(19) United States
(12) Patent Application Publication
(10) Pub. No.: US 2013/0266925 A1
(43) Pub. Date: Oct. 10, 2013

(54) Embedded Conversational Agent-Based Kiosk for Automated Interviewing

(71) Applicant: Arizona Board of Regents on Behalf of the University of Arizona, Tuscon, AZ (US)

(72) Inventors: Jay F. Nunamaker, JR., Tuscon, AZ (US); Judee K. Burgoon, Tuscon, AZ (US); Aaron C. Elkins, London (GB); Mark W. Patton, Tuscon, AZ (US); Douglas C. Derrick, Papillion, NE (US); Kevin C. Moffitt, Hillsborough, NJ (US)

(21) Appl. No.: 13/754,557

(22) Filed: Jan. 30, 2013

Related U.S. Application Data
(60) Provisional application No. 61/632,741, filed on Jan. 30, 2012.

(51) Int. Cl. G09B 7/00

(52) U.S. Cl. CPC G09B 7/00
USPC 434/362

(57) ABSTRACT

Methods and systems for interviewing human subjects are disclosed. A user interface of a computing device can direct a question to a human subject. The computing device can receive a response from the human subject related to the question. The response can be received using one or more sensors associated with the computing device. The computing device can generate a classification of the response. The computing device can determine a next question based on a script tree and the classification. The computing device can direct the next question to the human subject using the user interface of the computing device.

### CROSS-REFERENCE TO RELATED APPLICATIONS

The present application claims priority to U.S. Provisional Patent Application No. 61/632,741, entitled “Embodied Conversational Agent-Based Kiosk for Automated Interviewing” filed Jan. 30, 2012, which is entirely incorporated by reference herein for all purposes.

### STATEMENT OF GOVERNMENT RIGHTS

This invention is supported in part by the following grants: Grant No. H9C104-07-R-003 awarded by Counterintelligence Field Activity, Department of Defense; Grant Nos. IIP0701519, IIP1068026, and IIS0725895 awarded by the National Science Foundation; Grant No. N00014-09-1-0104 awarded by the Office of Naval Research; Grant Nos. F49620-01-1-0394 and FA9550-04-1-0271 awarded by the USAF/AFOSR; Grant No. DASWO1-00-K-0015 awarded by U.S. Department of the Army, Department of Defense; Grant Nos. 2008-ST-061-BS0002 and 2009-ST-061-MD0003 awarded by the Department of Homeland Security; and Grant No. NBCH203003 awarded by the U.S. Department of the Interior. The United States Government has certain rights in the invention.

### BACKGROUND OF THE INVENTION

Unless otherwise indicated herein, the materials described in this section are not prior art to the claims in this application and are not admitted to be prior art by inclusion in this section.

There are many circumstances when the intent and credibility of a person is rapidly and accurately determined. For example, transportation and border security systems have a common goal: to allow law-abiding people to pass through checkpoints and detain those people with hostile intent. These systems employ a number of security measures that are aimed at accomplishing this goal.

One example is when a person seeks entry into a country. At the border, the person can be interviewed to determine if they are importing goods into the country that require tax payment and/or may lead to harm to the country; e.g., explosives, guns, certain food products, soil from farms carrying microorganisms unknown to the country. The person can be interviewed about their intent upon entry to the country; e.g., questions about business or tourism plans, locations and persons within the country to be visited, etc.

In these cases, the questioning agents have to assess the credibility of the person seeking entry to decide if the person should be admitted to enter the country, or if some or all of their goods should be quarantined or taxed. However, having to make these assessments in a short time can fatigue even experienced agents. Further, even the most experienced agents can make incorrect assessments, which can lead to disgruntled entrants at best, and to possible security breaches at worst. For example, the general population of persons can detect lies at about a 54% success rate. Further, people often believe they are better lie detectors than these results warrant. Additionally, there may be significantly more persons seeking entrance to some locations of a country than there are agents available, leading to long delays in entry processing.

Achieving high information assurance is complicated not only by the speed, complexity, volume, and global reach of communications and information exchange that current information technologies now afford but by the fallibility of humans to detect non-credible persons with hostile intent. The agents guarding our borders, transportation systems, and public spaces can be handicapped by untimely and incomplete information, overwhelming flows of people and materiel, and the limits of human vigilance.

The interactions and complex interdependencies of information systems and social systems render the problem difficult and challenging. Currently, there are not enough resources to specifically identify every potentially dangerous individual around the world. Although completely automating concealment detection is an appealing prospect, the complexity of detecting and countering hostile intentions defies a fully automated solution.

### SUMMARY

In one aspect, a system is provided. The system includes a processor, a user interface, one or more sensors, and a non-transitory computer readable medium. The non-transitory computer readable medium is configured to store at least a script tree and instructions that, upon execution by the processor, cause the system to perform operations. The operations include: directing a question to a human subject using the user interface; receiving a response from the human subject related to the question using the one or more sensors; generating a classification of the response; determining a next question based on the script tree and the classification; and directing the next question to the human subject using the user interface.

In another aspect, a method is provided. A user interface to a computing device directs a question to a human subject. One or more sensors associated with the computing device receive a response from the human subject related to the question. The computing device generates a classification of the response. The computing device determines a next question based on a script tree and the classification. The user interface of the computing device directs the next question to the human subject.

In another further aspect, a non-transitory computer-readable storage medium is provided. The non-transitory computer-readable storage medium has stored thereon program instructions that, upon execution by a computing device, cause the computing device to perform operations. The operations include: directing a question to a human subject using a user interface to a computing device; receiving a response from the human subject related to the question using one or more sensors associated with the computing device; generating a classification of the response using the computing device; determining a next question based on a script tree and the classification using the computing device; and directing the next question to the human subject using the user interface of the computing device.

### BRIEF DESCRIPTION OF THE DRAWINGS

FIG. 1A illustrates an example kiosk.

FIG. 1B illustrates an example environment where multiple kiosks are operating simultaneously.

FIG. 1C illustrates an operator interface to a kiosk.

FIG. 2 illustrates an example model for a SPECIES agent that can be used with a kiosk.

FIG. 3 shows an intelligent agent architecture as part of the SPECIES system.

FIG. 4 is an example graph showing a decision variable along an X axis and plots of noise distribution and signal distribution functions with a decision criterion.

FIG. 5 shows an example state table with states and corresponding avatars for intelligent agents.

FIG. 6 includes images related to a “Bomb-Maker” experiment.

FIG. 7 is a block diagram of an example computing network.

FIG. 8A is a block diagram of an example computing device.

FIG. 8B depicts an example cloud-based server system.

FIG. 9 is a flow chart of an example method.

### DETAILED DESCRIPTION

### Overview

Described herein is an automated kiosk that uses embodied intelligent agents to interview individuals and detect changes in arousal, behavior, and cognitive effort by using psychophysiological information systems. A class of intelligent and embodied agents, which are described as Special Purpose Embodied Conversational Intelligence with Environmental Sensors (SPECIES) agents, use heterogeneous sensors to detect human physiology and behavior during interactions with humans. SPECIES agents affect their environment by influencing human behavior using various embodied states (i.e., gender and demeanor), messages, and recommendations. Based on the SPECIES paradigm, human-computer interaction can be evaluated. In particular, an evaluation can be made of how SPECIES agents can change perceptions of information systems by varying appearance and demeanor. Instantiations that had the agents embodied as males can be perceived as more powerful, while female embodied agents can be perceived as more likable. Similarly, smiling agents can be perceived as more likable than neutral demeanor agents.

The SPECIES system model encompasses five broad components: user interfaces, intelligent agents, sensors, data management, and organizational impacts. Like most intelligent agent systems, the paradigm for embodied-avatar interactions with humans involves an agent that perceives its environment through sensors, influences its environment via effectors, and has discrete goals. However, the SPECIES operating environment consists primarily of human actors in the real world. SPECIES agents are sensing human behaviors and human states such as arousal, cognitive effort, and emotion rather than discrete, easily measured and computed phenomena. Similarly, the SPECIES agents can utilize effectors to affect both humans and the environment.

SPECIES agents can use heterogeneous sensors to detect human physiology and behavior during interactions. These sensors are based on scientific investigation in computational modeling of emotion, deception, physiology, and nonverbal/verbal behavior, and the SPECIES agents affect their environment by influencing human behavior using various embodied states (i.e., gender and demeanor), messages, and recommendations. In particular, SPECIES agents modeling deception may have to account for several types of deception performed by human subjects, including but not limited to: lies including white lies, concealments, omissions, misdirections, bluffs, fakery, mimicry, exaggerations, deflections, evasions, equivocations, using strategic ambiguity, hoaxes, charades, costumes, and fraud.

SPECIES agents can be configured to use sensors that are not attached to a human subject to perform an unobtrusive non-invasive credibility assessment of the human subject. In some embodiments, a single sensor can measure vocal pitch to provide SPECIES agents with environmental awareness of human stress and deception. An avatar-based kiosk equipped with SPECIES agents can ask questions and measure the responses using vocalic measurements. The ability for automated agents, such as SPECIES agents, to adapt and learn from new information makes them ideal for dealing with complex and diverse phenomena.

In other embodiments, SPECIES agents can receive data from heterogeneous, non-invasive sensors and fuse these data to perform the credibility assessment. In addition to data from the above-mentioned vocal pitch sensor, data from cameras and computer vision systems, eye trackers, laser-Doppler vibrometers (LDVs), thermal cameras, and infrared cameras can be fused to perform an assessment taking into account a number of cues for deceptive behavior. In some scenarios, assessment based on data fused from a number of sensors, as well as human judgment, can lead to a true-positive rate of detecting deceptive behavior of about 90%.

Therefore, kiosks configured to use SPECIES agents can generate, receive, and process data from multiple sensors of multiple types and that data can be fused to better estimate whether a subject is under stress and/or trying to deceive. The kiosks and SPECIES agents can provide a real time, remote analysis of a human subject's credibility. For example, a person can make decisions rapidly (e.g., within 7 to 20 seconds) about another person's credibility, and so the kiosk is designed to perform at a similar rate. Kiosks and SPECIES agent are configured to perform interviews consistently, and in some embodiments, determine questions that have high diagnostic value for assessing credibility.

The SPECIES agents were created and put into the kiosk to conduct automated interviews and determine human veracity during each interview. Intelligent agents can aid humans in making complex decisions and rely on artificial intelligence to evaluate context, situation, and input from multiple sensors in order to provide a distinctive recommendation. Agent-based systems can make knowledge-based recommendations and exhibit human characteristics such as rationality, intelligence, autonomy, and environmental perception_{]}. For example, the environmental perception can be based on human behavior and physiological responses.

Kiosks with embedded SPECIES agents can improve the effectiveness of screening environments for a number of reasons. Kiosks can be replicated and deployed to alleviate the traffic load placed on human agents and can be built to speak a variety of languages. Kiosks do not get fatigued or have biases that interfere with the quality of screening at checkpoints. Automated embodied agents in the kiosks can detect cues of deception and malicious intent that would normally be very difficult for a trained human to detect. Kiosks can be used to provide a quick, convenient system for providing travelers with standardized interviews and self-service screening.

Example Kiosk with Embedded Species Agents

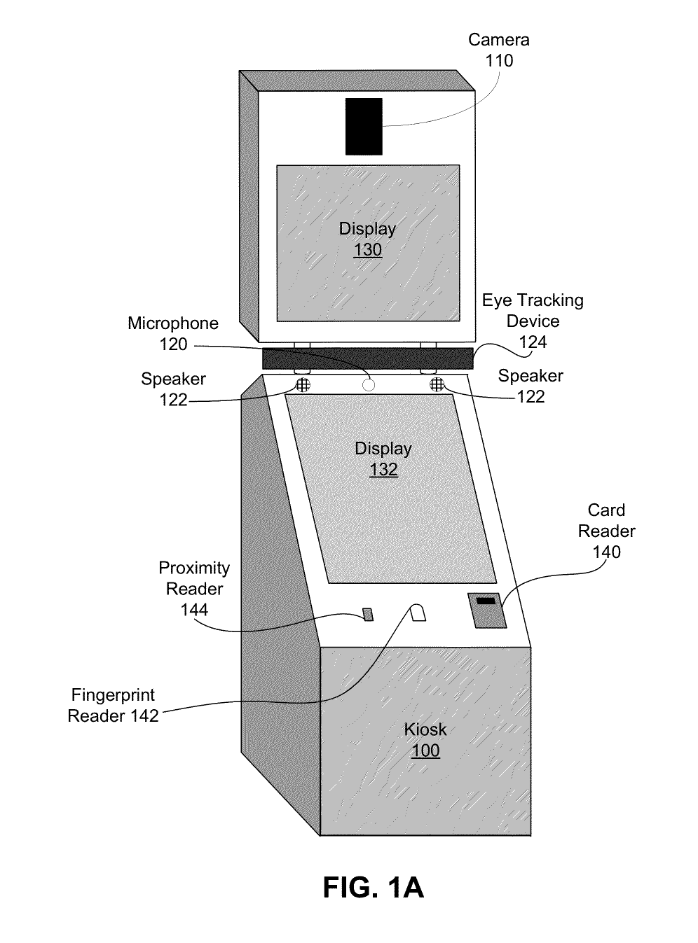

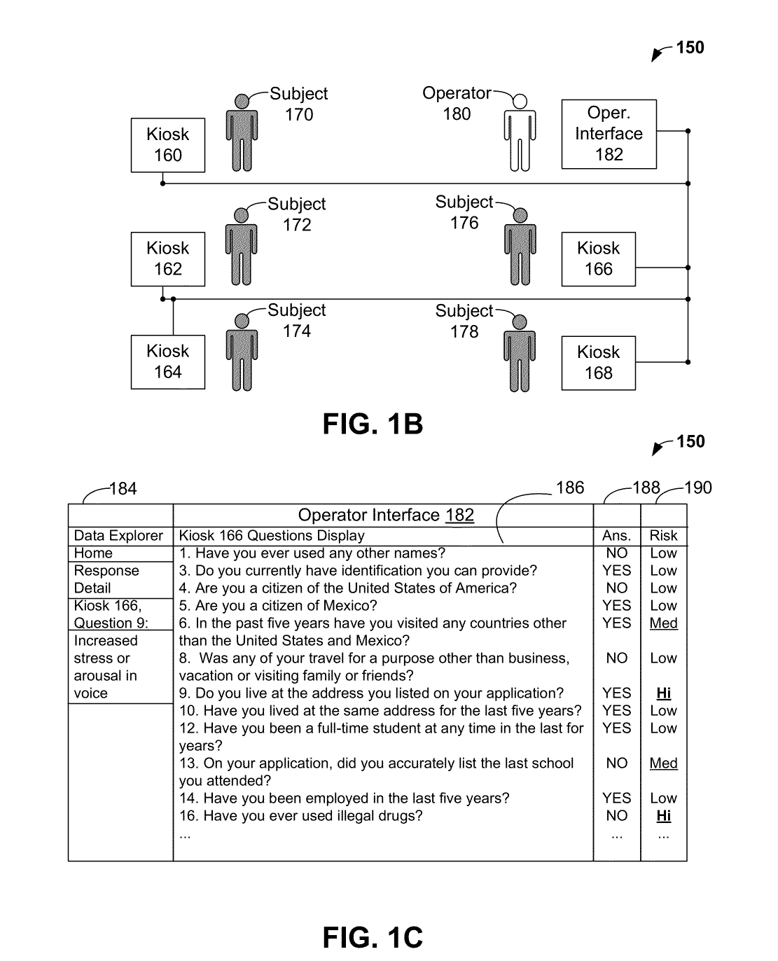

FIG. 1A shows an example kiosk 100. As shown in FIG. 1, kiosk 100 can contain several sensors, such as a high-definition video camera 110, microphone 120, speakers 122, eye tracking device 124, displays 130, 132, card reader 140, fingerprint reader 142, and proximity reader 144. In some cases, at least display 132 is configured with a touch screen to enable touch-based input; e.g., as provided by a human subject using kiosk 100. In some embodiments, kiosk 100 can be equipped with additional cameras, such as a near-infrared and/or infrared cameras, still cameras, and/or other types of cameras.

Kiosk 100 can be used to interview a human subject. For example, an “avatar” or image(s) representing an embedded conversational agent (ECA), such as a SPECIES agent, can be displayed; e.g., using monitor 130, and ask questions of the human subject via speech (and perhaps other sounds) emitted using speakers 122. The SPECIES models can include avatars having full physical representations, or just a part of the body such as a head and face. There are several reasons to use an embodied face over only sound and text when communicating and interacting with individuals. The face, especially the lower face, can be very useful conveying emotions visually, and so embodied agents can effectively communicate an intended emotion through animated facial expressions alone.

A SPECIES agent utilizes human interaction as a control component. Humans manifest a state of arousal through several physiological responses including pupil dilation, change in heart rate and blood pressure, change in blood flow, increase in body temperature, especially around the face and eyes, and changes in blink patterns. Sensors of kiosk 100 can capture both physiological and behavioral cues from the human counterparts. Physiological cues that may be diagnostic of emotional state, arousal, and cognitive effort include heart rate, blood pressure, respiration, pupil dilation, facial temperature, and blink patterns. Behavioral indicators include kinesics, proxemics, chronemics, vocalics, linguistics, eye movements, and message content.

The human subject can provide direct input using the touch screen of display 132 for touch-based inputs and/or microphone 120 for speech-based inputs. The human subject can also be observed using camera 110. Kiosk 100 can accept documentation related to the human subject; e.g., passports, identity cards, etc. For example, kiosk 100 can accept documentation via proximity reader 140; e.g., for reading Radio Frequency ID (RFID) provided documentation and/or card reader 144; e.g., for reading one-dimensional (bar code) and two-dimensional (QR code) encoded information, magnetic media encoding documentation, and/or alphanumeric documentation. Also, the human subject can provide kiosk 100 with fingerprint data, as needed, using fingerprint reader 142.

In other embodiments, kiosk 100 can be configured with more, different, and/or fewer sensors and/or output devices; e.g., kiosk 100 can be configured with a laser-Doppler vibrometer, different types of cameras, and/or eye tracking sensors. In some other embodiments, card reader 144 can include an electronic passport reader, such as the 3M AT-9000 e-passport reader. The e-passport reader can read information from a document, such as a passport or visa, and/or capture an image of the document.

FIG. 1B illustrates an example environment 150 where five kiosks 160, 162, 164, 166, 168 are operating simultaneously to interview five subjects 170, 172, 174, 176, and 178. For example, environment 150 can be at a border crossing location or port of entry, where subjects 170-178 are being interviewed about their respective immigration and/or customs status.

Kiosks 160-168 are being operated by operator 180, who can observe questioning, review answers, and observe kiosk operation via operator interface 182 to kiosks 160-168. In this fashion, five subjects 170-178 can be interviewed with only one human operator, enabling both faster and uniform interview service for subjects 170, 172, 174, 176, and 178 and for fewer human resources to be used in routine interviewing. Each of kiosks 160-168 can be embodied by kiosk 100.

The use of one or more kiosks, such kiosks 160-168 in environment 150, can be a scalable solution for interviewing and generating credibility assessments that remains robust in high-traffic scenarios. Kiosks can be used in a number of different contexts and cultures to obtain information about human subjects and assess the credibility of the responses provided by the human subjects, while reducing the number of human operators to interview the subjects.

FIG. 1C illustrates operator interface 182 to a kiosk. Operator interface 182 can be displayed on a tablet, smart phone, laptop, or desktop computer equipped with suitable software. In some embodiments, a kiosk, such as kiosk 100, can be configured to perform the operations described herein being performed by operator interface 182.

Operator interface 182 receives information from one or more kiosks and displays that information for used by an operator, such as operator 180. Operator interface 182 includes a data explorer interface 184, questions display 186, answer display 188, and risk assessment display 190. Data explorer interface 184 enables the operator to learn more about a specific question, answer, and/or risk assessment. FIG. 1C shows that data explorer interface 184 used to provide additional information about an answer received by “kiosk 166” about “question 9” where kiosk 166 detected “increased stress or arousal in voice”. In other scenarios, data explorer interface 184 can provide information about historical responses to questions, risk assessments, past responses made by a subject to questions shown in question display 186, information about a subject providing answers to a kiosk, and/or other information.

Questions display 186 can be used to display questions asked (or to be asked) and answered by a kiosk to a subject. In the example shown in FIG. 1C, questions display 186 shows example questions for a border crossing between the United States of America and Mexico asked by kiosk 166 of subject 176, such as question 1 “Have you ever used any other names?” and question 3 “Do you currently have identification you can provide?” In some embodiments, such as shown in FIG. 1C, question display 186 can display a source kiosk where questions in question display 186 were asked. For the example shown in FIG. 1C, question display includes questions asked by “Kiosk 166”. In some embodiments, operator interface 182 can permit operator 180 to switch between kiosks being reviewed; e.g., to switch from a current kiosk; e.g., “Kiosk 166” to another kiosk; e.g., kiosk 164. In still other embodiments, operator interface 182 can permit simultaneous review of multiple kiosks; e.g., operator interface 182 can provide multiple windows, where each window provides a display for a predetermined kiosk, such as the display for kiosk 166 shown in FIG. 1C.

Answer display 188 shows answers provided by subject 176 to questions 186 at kiosk 166. In some embodiments, such as shown in FIG. 1C, the answers can be “Yes” and “No” answers; while in other embodiments, other answers can be provided, such as, but not limited to, numerical answers, additional words beyond “Yes” and “No”, image files, video files, and sound files. Each answer in answer display 188 corresponds to a question in question display 186; e.g., question 1 in questions display 186 of “Have you ever used any other names?” is shown to be answered with a “NO” in answer display 188.

Risk assessment display 190 shows a risk assessment for each answer shown in answer display 188. For example, risk assessment display 190 shows a “Low” risk for the answer “NO” shown in answer display 188 to the “Have you ever used any other names?” question shown in question display 186. In the embodiment shown in FIG. 1C, a “Hi” for high risk, “Med” for medium risk, and “Low” risk scale is used to display risk, with each of the “Hi”, “Med”, and “Low” risks being displayed using different textual styles. FIG. 1C shows the “Hi” risk assessment using underlining and a bold font; e.g., Hi, the “Med” risk assessment using underlining; e.g., Med, and the “Low” risk assessment in using an unaccented or normal font; e.g., Low. In some embodiments, the risk assessment can be displayed using numerical values, colors, images/icons, and/or using other techniques. In particular embodiments, answer display 188 and risk assessment display 190 can be combined; e.g., a displayed answer can be shown using “stoplight colors”: a red color to indicate a high risk assessment, a yellow color to indicate a medium risk assessment, or a green color to indicate a low risk assessment. Other techniques for exploring data and displaying questions, answers, and risk assessments are possible as well.

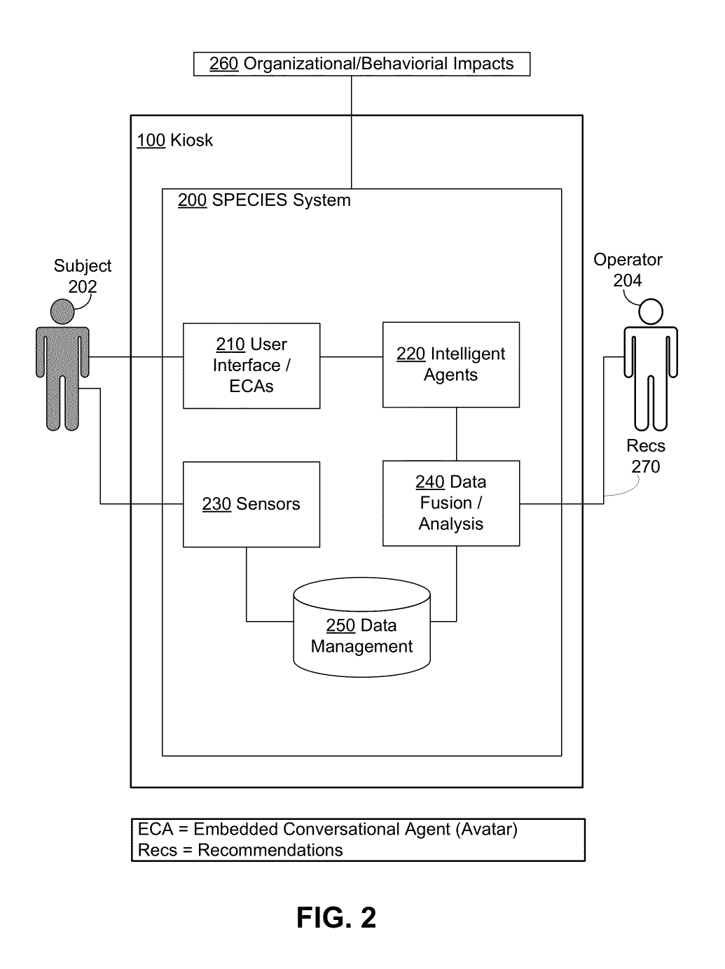

FIG. 2 shows an example model 200 for a SPECIES agent that can be used with kiosk 100. SPECIES model 200 can include user interfaces/embedded conversational agent component 210, intelligent agent component 220, sensor component 230, data fusion/analysis component 240, data management 250 component, and organizational/behavioral impacts 260 component. SPECIES model 200 involves a user interface with ECA(s) 210 and intelligent agent 220 that can perceive its environment through sensors 230, influences its environment via effectors, and has discrete goals. An effector is a device used or action taken by an artificially intelligent agent in order to produce a desired change in an object or environment in response to input.

However, the SPECIES operating environment consists primarily of human actors in the real world, which makes it difficult to access, difficult to represent, and difficult to influence. This operating paradigm is unique because the SPECIES agents are sensing human behaviors and human states such as arousal, cognitive effort, and emotion rather than discrete, easily measured and computed phenomena. Similarly, the SPECIES agents can utilize a variety of effectors to affect both humans and the environment. These effectors may include human influence tactics, impression management techniques, communication messages, agent appearance, agent demeanor, and potentially many other interpersonal communication and persuasion strategies. One example of these effectors are recommendations 270 that SPECIES system 200 can make to operator 204 in order to evaluate subject 202.

In operation, embodied conversational agents, perhaps visualized as an avatar, of user interfaces/embedded conversational agent component 210 can send messages and signals to subject 202. Sensors component 230 can receive data from sensors of kiosk 100 that are related to human behavior and psychophysiological signals of subject 202. For example, an avatar can ask subject 202 a question and sensors component 230 can detect data related to vocal, visual, and/or other cues provided by subject 202 responding to the question. Intelligent agents component 220 can send messages and controls to user interfaces/embedded conversational agent component 210 that act as effectors to change the embodied appearance of an avatar; e.g., to make facial and/or head gestures related to responses provided by subject 202. Sensors component 230 can store the data related to cues provided by subject 202 and/or other data using data management component 250. Data fusion/analysis component 230 can utilize data stored by data management component 240 and observations made by intelligent agents component 220 to generate recommendations 270 for review by operator 204. For example, data management component can be or include a storage area network (SAN). Organizational/behavioral impacts 260 component can send and receive data, commands, and/or other information related to privacy, ethical, and policy considerations.

### Virtual Actors: Avatars, Embodied Agents, and Embodied Conversational Agents

As disclosed herein, embodied agents refer to virtual, three-dimensional human likenesses that are displayed on computer screens. While they are often used interchangeably, it is important to note that the terms avatar and embodied agent are not synonymous. Collectively, avatars, embodied agents, and embodied conversational agents are termed virtual actors. Table 1 below indicates some distinctions between types of virtual actors.

TABLE 1

| | | Automated | | |
|---|---|---|---|---|
| | | control | | |
| Type of Virtual | 3D | (intelligent | Human | Communicate |
| Actor | Representation | agent) | Control | via Speech |
| Avatar | Yes | No | Yes | Maybe |
| Embodied | Yes | Yes | No | No |
| Agent | | | | |
| Embodied | Yes | Yes | No | Yes |
| Conversational | | | | |
| Agent | | | | |

Humans engage with virtual actors and respond to their gestures and statements. If an embodied agent is intended to interact with people through natural speech, it is often referred to as an embodied conversational agent. When the embodied agents react to human subjects appropriately and make appropriate responses, participants report finding the interaction satisfying. At the same time, when a virtual actor fails to recognize what humans are saying, and respond with requests for clarification or inappropriate responses, humans can find the interaction very frustrating.

People interacting with embodied agents tend to interpret both responsive cues and the absence of responsive cues. The nonverbal interactions between individuals include significant conversational cues and facilitate communication. Incorporating nonverbal conversational elements into a SPECIES agent can increase the engagement and vocal fluency of individuals interacting with the agent. While humans are relatively good at identifying expressed emotions from other humans whether static or dynamic, identifying emotions from synthetic faces is more problematic. Identifying static expressions is particularly difficult, with expressions such as fear being confused with surprise, and disgust and anger being confused with each other.

When synthetic expressions are expressed dynamically, emotion identification improves significantly. In one study on conversational engagement, conversational agents were either responsive to conversational pauses by giving head nods and shakes or not. Thirty percent of human storytellers in the responsive condition indicated they felt a connection with the conversational agent, while none of the storytellers to the nonresponsive agents reported a connection. In this study, intelligent agent responsiveness was limited to head movement, and facial reactions were fixed. Subjects generally regarded responsive avatars as helpful or disruptive, while 75 percent of the subjects were indifferent toward the nonresponsive avatars. Users talking to responsive agents spoke longer and said more, while individuals talking to unresponsive agents talked less and had proportionally greater disfluency rates and frequencies.

Agents that are photorealistic should be completely lifelike, with natural expressions, or else individuals can perceive them negatively and a disembodied voice is actually preferred and found to be clearer. When cartoon figures are utilized, three-dimensional characters can be preferred over two-dimensional characters and whole-body animations are preferred over talking heads.

The SPECIES agent can send signals and messages via its rendered, embodied interface to humans to affect the environment and human counterparts. The signals available to the SPECIES agent take on three primary dimensions, which are visual appearance, voice, and size. The visual appearance can be manipulated to show different demeanors, genders, ethnicities, hair colors, clothing, hairstyles, and face structures. One study of embodied agents in a retail setting found a difference in gender preferences. Participants preferred the male embodied agent and responded negatively to the accented voice of the female agent. However, when cartoonlike agents were used, the effect was reversed and participants liked the female cartoon agent significantly more than the male cartoon.

Emotional demeanor is an additional signal that can be manipulated as an effector by the SPECIES agent based on its desired goals, probable outcomes, and current states. The emotional state display may be determined from the probability that desired goals of the SPECIES agent will be achieved. Emotions can be expressed through the animation movements and facial expressions, which may be probabilistically determined based on a SPECIES agent's expert system. Voice parameters such as pitch, tempo, volume, and accent do affect perceptions that humans have of the embodied agents. The size component is strictly the dimensions of the embodied communicator. Consistent with human gender stereotypes, it is likely that a large male avatar may be initially perceived as more dominant than a small female avatar.

### Detecting Deception Using Sensors

Deception can be detected using one or more of five classes of indicators, divided into “nonstrategic” and “strategic” classes of indicators. Nonstrategic classes of indicators concern non-rational, uncontrollable and/or uncontrolled behaviors, which include arousal-based indicators, emotion-based indicators, and memory-based processes. Strategic classes of indicators concern thoughtful, premeditated, planned, rehearsed, and/or monitored behaviors, which include behavioral control and communication-based strategies and tactics.

Arousal-based indicators are indicators related to observations detecting higher psychophysiological activation during deceptive activities. Emotion-based indicators are indicators related to non-verbal cues of guilt or fear and use of emotional language. Memory-based processes involve recollections of imagined, rather than real, events. Behavior controls relate to efforts by a human subject to hide or control telltale signs of deception. Communication strategies and tactics relate to efforts by a human subject to manage what is said and to control a demeanor/self-presentation of the subject.

In an operating environment for kiosk 100, sensors can accurately detect the state of individuals in the real world. Kiosk 100 can include several sensors that perform noncontact monitoring of individuals as they are placed in various stressful and cognitively difficult interactions. As discussed above in the context of FIG. 2, data from sensors in kiosk 100 can be collected by sensors component 220 and stored using data management component 240.

Table 2 below shows an example list of sensors used for data collection, corresponding psychophysiological and behavioral measures being observed, and information that can be abstracted or generated from the sensor data. The data were collected separately by the sensors and processed after collection. A SPECIES agent can presently control some sensors; e.g., the video camera, microphone, and near infrared camera for monitoring human eye behavior.

TABLE 2

| | Psychophysiological | Abstracted |
|---|---|---|
| Sensors Used for Data | and Behavioral | Response |
| Collection | Measures | Information |
| Video Cameras | Linguistics | Anxiety |
| Microphones | Vocalics | Arousal |
| | Kinesics | Emotion |
| | | Cognitive states |
| Laser-Doppler Vibrometer | Blood Pressure | Arousal |
| | Heart Rate | Emotional stress |
| | Respiration | Cognitive effort |
| Thermal Camera | Facial/Orbital | Deception |
| | Body Temperature | Emotional states |
| | Perspiration | Blushing |
| | | Embarrassment |
| | | Threat responses |
| | | Surprise |
| Pupillometric Near Infrared | Iris Identification | Familiarity |
| Camera | Pupil Dilation | Arousal |
| | | Stress |
| Ultra-fast Near Infrared | Blink Frequency | Arousal |
| Camera | Startle Response | Emotional States |
| Eye Tracker | Gaze Behavior | Memory Processes |
| | Object Recognition | Message Production |
| | Pattern Classification | Communication |
| | | Strategies |

Microphones and high quality audio recording equipment can be used for speech recognition and to record the responses. Also, recorded speech can be passed through vocal signal processing software to classify emotional and cognitive states using vocalic cues. Commonly, vocalic cues fall into three general categories, which include time (e.g., speech length, speech tempo, latency), frequency (e.g., pitch), and intensity (e.g., amplitude). An increase in vocal frequency, intensity, and/or vocal tempo can be associated with arousal, which may result from anxiety. In many persons, the muscles about the larynx become tense during stress, which leads to higher-frequency speech. Received speech can be subject to linguistic analysis as well.

Vocalic cues also can be generated using advanced signal processing. The advanced signal processing can be used to generate a computational model of techniques used by humans to decode sounds in our minds. For example, a slow feature analysis of recorded sounds can detect slowly varying features from quickly varying signals of the recorded speech. These slowly varying features may model features of speech that humans use in determining deceptiveness of speech. Thus, the slow features from the signal processing analysis can be used as vocalic cues to aid determination of the recorded speech as deceptive or non-deceptive.

Cameras, along with the use of computer vision techniques, can be used to extract information from images or video. Computer vision techniques have been used to detect kinesic movements from video, including facial expressions, gaze, head movements, posture, gestures, limb movements, and gross trunk movements. These movements have been shown to be predictive of arousal, emotional states, memory processes, message production, and communication strategies. Common computer vision methods include, but are not limited to, active shape modeling and blob analysis.

Slow feature analysis can be applied to visual data captured by the cameras. These slow features, such as object identify and object location, are rooted in how humans perceive visual stimuli. Other slow features can be used to identify facial behaviors to segment behaviors into onset, apex, and offset stages. For example, video frames taken of subjects asked a series of questions can be extracted and segmented by question. The face and facial features of the subjects can be tracked; for example, mouth, eye, and brow locations can be extracted from each video frame.

Features can be extracted using a number of feature extraction methods, such as, but not limited to Histogram of Oriented Gradients (HOG) and Gabor filters for edge detection, local binary patterns (LBP) and intensity measures for texture, and dense optical flows for motion detection. The feature extraction measures can convert input video frames into feature vectors containing relevant information. Change ratios for each of the tracked mouth, eye, and brow locations can be determined during the slow feature analysis. For example, in some persons, change ratios for a feature can be used to identify relatively large changes in a feature, such as brow, eye, or mouth location. Further, by determining change ratios for multiple features of the same data, simultaneous changes in the multiple features can be detected; for example, during the apex of a facial expression, a person's mouth and brow may go up by a maximum amount while their eyes go down by a maximum amount. Determining such combinations of movements can identify facial expressions for a given person or numbers of persons.

An example sensor for non-invasively capturing cardiorespiratory measurements is the Laser Doppler Vibrometer which uses laser imaging and Doppler sound waves to measure pulsations of the carotid artery in a visible portion of the neck. Laser Doppler technology is based on the theoretical concept that internal physiology has mechanical components that can be detected in the form of skin surface vibrations. The system utilizes a class-2 (medically safe) laser and the Doppler Effect to sense and measure vibrations in the carotid artery by targeting the carotid triangle. The multiple cardiorespiratory measures that are obtained are used to differentiate among stress and emotional states. Pulse rate, blood pressure, and respiration rate have been shown to be reliable indicators of arousal. These measures are sensitive to emotional stress and increases in cognitive effort. Cardiovascular measures are particularly appealing because they are involuntary, even when breathing can be regulated. Also, recent studies have shown that individuals tend to inhibit breathing when faced with stress.

A Laser Doppler Vibrometer has been used to determine a cardiovascular measure of interbeat interval (IBI) in the context of a Concealed Information Test (CIT) involving guilty and innocent actors. In an experiment, participants were randomly assigned to be guilty or innocent, and received associated instructions. The procedures were intended to heighten anxiety and simulate the circumstances surrounding actual criminal conduct and so interaction with laboratory personnel was restricted. Substantial monetary bonuses were offered to participants judged as credible, and by having the “crime” committed realistically. Guilty actors were asked to take part in a mock theft by taking a ring from a receptionist's desk and then attempting to conceal their actions during a subsequent credibility assessment. Innocent actors were instructed to report to the same locations as guilty actors, cooperate with the credibility assessment process, and be completely truthful.

Both guilty and innocent actors next reported to a nearby building, where they visited a reception office and asked for a fictitious Mr. Carlson. While the receptionist was ostensibly searching for Mr. Carlson, the guilty actors stole a diamond ring contained in a blue cashbox hidden under a tissue box within a desk drawer. The details of the crime were known only to the guilty. The “innocent” participants simply waited in the reception office until the receptionist returned and sent them to be interviewed.

Professional interviewers questioned all participants using a standardized interview protocol that consisted of a series of 24 short-answer and open-ended questions, CIT, and 10 questions during which the startle-blink manipulation was administered. The professional interviewer made a guilty or innocent judgment, which determined if participants received their monetary bonus. During the interview, sensors measured the participant's pupil dilation, pre-orbital temperature, cardiorespiratory activity, blink activity, kinesics (movements), and vocalics. Participants then completed a post-interview survey and were debriefed.

For the CIT, interviewers asked three questions:

1. If you are the person who stole the ring, you are familiar with details of the cash box it was stored in. Repeat after me these cash box colors: (a) green, (b) beige, (c) white, (d) blue, (e) black, (f) red.

2. If you are the person who stole the ring, you moved an object in the desk drawer to locate the cash box containing the ring. Repeat after me these objects: (a) notepad, (b) telephone book, (c) woman's sweater, (d) laptop bag, (e) tissue box, (f) brown purse.

3. If you are the person who stole the ring, you know what type of ring it was. Repeat after me these types of rings: (a) emerald ring, (b) turquoise ring, (c) amethyst ring, (d) diamond ring, (e) ruby ring, (f) gold ring.

Initial LDV data was reduced, as the targeting and tracking system was unable to target the carotid triangle because the interviewee moved too much, occluding the carotid triangle. The data were then processed to identify acceptable cardiovascular pulses and compute the IBI for each CIT item. IBI deceleration magnitude is the maximum IBI between two consecutive heartbeats in a six second period after a CIT item was repeated by the participant. The six second-analysis periods were shortened when these intervals got too close to the beginning of the next CIT item. The decelerations following each of the neutral items' responses were averaged together, excluding the first and last neutral items in each se. Lastly, a single score was calculated for the expected deceleration for each participant by averaging the IBI decelerations for the remaining neutral CIT items. 21 of 87 initial records were rejected due to abnormal heartbeats and insufficient data. Using the neutral IBI CIT item deceleration averages and the decelerations based on the key items, the remaining 66 participants were classified as either guilty (where deceleration was greater after key items) or innocent for each CIT set and combination. Table 3A shows the results of this classification.

TABLE 3A

| CIT set | | True- | False- | True- | False- |
|---|---|---|---|---|---|
| (N = 66, 30 guilty, 36 | Accuracy | positive | positive | negative | negative |
| innocent) | (%) | rate (%) | rate (%) | rate (%) | rate (%) |
| Colors | 56.1 | 43.3 | 33.3 | 66.7 | 56.7 |
| Objects | 63.6 | 66.7 | 38.9 | 61.1 | 33.3 |
| Rings | 66.7 | 76.7 | 41.7 | 58.3 | 23.3 |
| Colors and objects | 59.1 | 36.7 | 22.2 | 77.8 | 63.3 |
| Objects and rings | 68.2 | 60.0 | 25.0 | 75.0 | 40.0 |
| Colors and rings | 66.7 | 36.7 | 8.3 | 91.7 | 63.3 |
| Colors, objects, and | 65.2 | 33.3 | 8.3 | 91.7 | 66.7 |
| rings | | | | | |

The true-positive rate (TPR) is the percentage correctly classified as guilty and the true-negative rate (TNR) is the percentage classified as innocent. The false-positive rate (FPR) is the percentage incorrectly classified and the false-negative rate (FNR) is the percentage incorrectly classified as innocent.

A border-crossing context is a high-stakes environment, so the false-positive rate can be weighed against the false-negative rate. If the false-negative rate is high, it means that potential criminals are undetected in the screening process. If the false-positive rate is high, it means that innocent people are being subjected to additional screening. Based on this objective, the ring CIT set performed the best according to the data in Table 3A, catching 77 percent of the criminals according to the true-positive rate, but at the cost of 42 percent innocent people being accused according to the false-positive rate. This trade-off might be appropriate in a high-risk situation.

TABLE 3B

| FOIL set | | | | | |
|---|---|---|---|---|---|
| (N = 66, 30 guilty, 36 | Accuracy | TPR | FPR | | |
| innocent) | (%) | (%) | (%) | TNR (%) | FNR (%) |
| Human judgment | 71.2 | 70.0 | 27.8 | 72.2 | 30.0 |
| Human and LDV color | 57.6 | 20.0 | 11.1 | 88.9 | 80.0 |
| Human or LDV color | 69.7 | 93.3 | 50.0 | 50.0 | 6.7 |
| Human and LDV | 66.7 | 43.3 | 13.9 | 86.1 | 56.7 |
| object | | | | | |
| Human or LDV object | 68.2 | 93.3 | 52.8 | 47.2 | 6.7 |
| Human and LDV ring | 71.2 | 53.3 | 13.9 | 86.1 | 46.7 |
| Human or LDV ring | 66.7 | 93.3 | 55.6 | 44.4 | 6.7 |
| Human or LDV object | 74.2 | 93.3 | 41.7 | 58.3 | 6.7 |
| Human or color and | 78.8 | 90.0 | 30.6 | 69.4 | 10.0 |
| object and ring | | | | | |

Table 3B above shows human interviewers performed at 71.2% accuracy in 66 cases. However, they had a false negative rate of 30.0 percent, meaning that almost one-third of all the criminals went undetected.

Sensor networks can be more effective when data, such as LDV sensor data, are fused with human judgments about interviews. For example, the sensor and human data can be “fused” or merged using data fusion analysis component 240, which can fuse data from different sources based one or more formulas. For example, human judgment data and LDV data can be fused based on the following formula:

Classification=HumanJudgment∪LDVColor∩LDVObject∩LDVRing.

In some cases, fusing human judgments with LDV sensor classifications can improve results. Using the above formula to generate a classification of responses to CIT questions, the overall accuracy improves to 78.8 percent. More importantly, the FNR is decreased to 10 percent and the TPR increases to 90 percent, while only increasing the FPR by 2.8 percent.

Thermal imaging technology, such a FLIR thermal camera, can measure changes in regional facial blood flow, particularly around the eyes. Changes in the orbital area may reflect changes in blood flow related to the fight-or-flight response mediated by the sympathetic nervous system. Assessments of the human state are based on the temperature signal patterns identified during the interaction. As illustrated in Table 2 above, thermal imaging can be used to detect deception, emotional states, blushing, embarrassment, threat responses, and surprise.

Pupillometry is the study of changes in pupil size and movement, which has been suggested to be an orienting reflex to familiar stimulus. Pavlov originally studied the orienting reflex during his classical conditioning experiments. This reflex orients attention to novel and familiar stimuli and is considered adaptive to the environment. Pupil dilation can also result from sympathetic nervous system stimulation or suppression of the parasympathetic nervous system. These peripheral nervous system responses are theorized to reflect arousal or stress, which result in pupil dilations. Difficult cognitive processes and arousal have been found to impact pupil response. Pupillometry can be measured through the use of low-level near-infrared cameras. The infrared light is slightly outside the spectrum of visible light and therefore does not cause changes in the pupil.

An EyeTech eye tracker, which includes a gaze tracker, can be used to capture eye behavior responses. Specifically, the EyeTech Digital Systems VT2 can track gaze patterns and pupil dilation as people look at images. The VT2 has two near-infrared light sources that are outside of the spectrum of visible light and an integrated infrared camera. It connects via USB to a Windows computer and captures eye gaze location (x, y coordinates) and pupil dilation data at a rate of approximately 33-34 frames per second. Subjects must gaze in the direction of the sensor to accurately capture data. For example, if images are displayed on a computer screen, the EyeTech Digital Systems VT2 can be mounted directly below the computer screen to capture gazes of a human viewing the images.

The sensor architecture for the kiosk can be based on service-oriented components so each sensor will fit into the SPECIES architecture. A scalable sensor network framework suitable for fusion and integration can be utilized by a SPECIES-based decision support system, such as SPECIES system 200 discussed above. In some embodiments, a modular agent-based architecture that promotes standardized messaging and software interfaces for interoperability of diverse sensors can be used. The modular agent-based architecture can integrate disparate sensors into a network for real-time analysis and decision support. In the most general sense, a SPECIES agent can have robust-enough sensors and an integrated network in order to perceive and represent the stochastic real world.

### System Design for Intelligent Agents

An intelligent agent coordinates perception, reasoning, and actions to pursue multiple goals while functioning autonomously in dynamic environments. The kiosk software can be based on well-defined software engineering and system engineering methodologies.

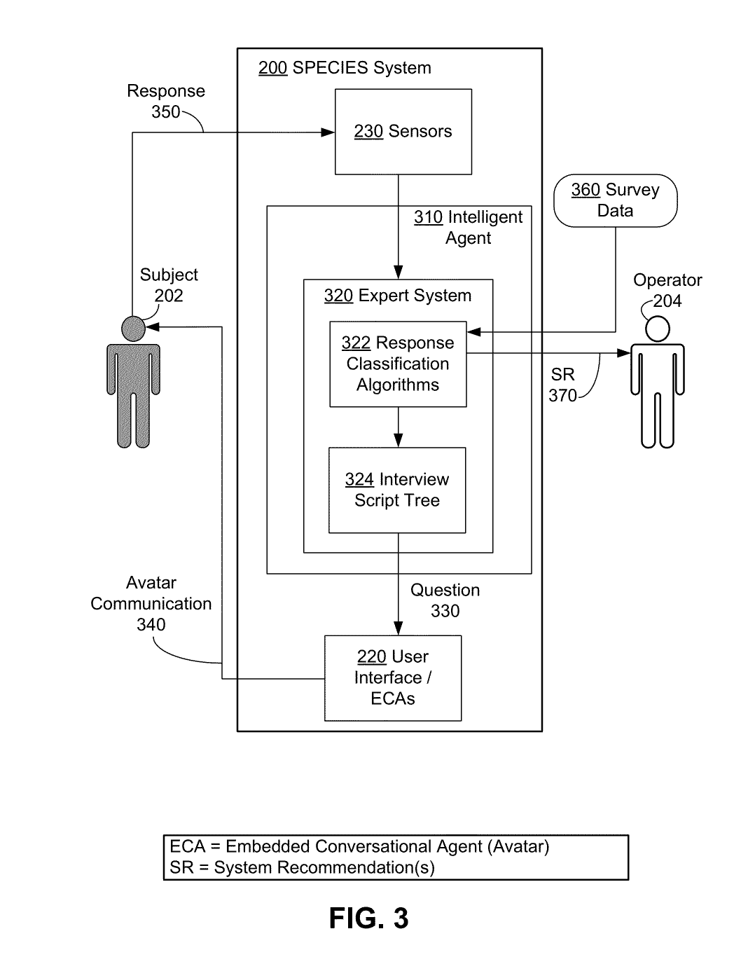

FIG. 3 shows an intelligent agent architecture as part of SPECIES system 200. As described herein, intelligent agent 310 has a variety of behaviors, messages, genders, and demeanors that it can employ for human interaction. Intelligent agent 310 includes expert system 320 with response classification algorithms 322 and script tree 324 that were designed based on interviews and collaboration with polygraph examiners. These professional interviewers helped formulate the questions in script tree 324, and classification algorithms 322 are based on the measured effects during the interviews. When classification algorithms 324 detect arousal and cognitive effort in the subject, it is possible for intelligent agent 310 to take different paths in interview script tree 324 in generating question 330. In some scenarios, subject 202 provides survey data 360 before, during, or after interaction with intelligent agent 310. Survey data 360 can

SPECIES system 200 can utilize user interface/embedded conversational agents 220 to pose question 330 to subject 202 via avatar communication 340. Avatar communication 340 can include use of an animated avatar, such as an animated face and head of an agent including head and facial gestures, generated text, and/or providing audible speech based on question 330, such as converting text of question 330 to speech. In some embodiments, question 330 can be one language, translated to a second language, and avatar communication 340 can include text and/or audible speech of question 330 after translation to the second language.

SPECIES agents, such as intelligent agent 310, can adhere to four interpersonal communication principles to conduct meaningful, persuasive, and human-like communication. In summary, SPECIES agents, such as intelligent agent 310, can: 1) engage in purposeful communication with subject 202, 2) decode human messages, such as response(s) 350, through sensors 230, 3) interpret sensor information from sensors 310 to formulate responses such as question 330, and 4) encode responses, for example as avatar communication(s) 340, to relay to subject 202.

SPECIES agents are special-purpose conversational agents. That is, a SPECIES agent can have a special purpose—a concrete context and purposeful communication objective. An analysis of the characteristics of the task the SPECIES agent performs has influenced the design of the SPECIES agent to accomplish that special purpose. Examples of special purposes could include conducting an interview for a specific job, detecting deception at a border crossing, or assessing learning for an online class. Designing an agent for a special purpose limits the context and interpretation requirements placed on the SPECIES agent. Unlike general purpose conversational agents, SPECIES agents are bounded in their expertise, vocabulary, and context depending on their specified purpose. This allows more manageable and in-depth interactions with human counterparts because it restricts the scope of interpretation and conversation that can be performed. Designing special purpose agents also allows the designer to focus on the purpose of the agent. Critical design questions to determine the special purposes of SPECIES agents include:
What is the task this agent intends to automate?
What is the goal of the agent?
What is the context in which people will interact with this agent?
What embedded knowledge can be included into the agent to carry out this task or reach the goal?
How can this knowledge be represented?

Another benefit of this design principle is that it provides an objective for intelligent agent 310. As intelligent agent 310 decodes (through sensors) response(s) 350 and encodes avatar communications 340 (with effectors), its embedded purpose is the driving force during communication with subject 202. For example, if one agent's goal is to calm down a frustrated human and another agent's goal is to create arousal in another human, each agent will take a different action during the encoding phase.

One aspect of a SPECIES agent, such as intelligent agent 310, is that agent 310 can naturally interact with a person. In a human interpersonal communication context, decoding is done through human senses such as hearing and sight. Intelligent agent 310 sensing can be accomplished through electronic sensors 230 that can include visible light cameras, thermal cameras, microphones, and laser Doppler monitoring, as discussed above regarding Table 2. Sensors 230 can vary depending on what information intelligent agent 310 needs to analyze to create an appropriate response.

In detecting responses, human states, emotions, and responses can rarely be reliably detected using only one sensor. For example, there is no “silver bullet” sensor for detecting deception. To accurately detect deception, data from several sensors can be combined. The following questions can guide choosing sensors for use with intelligent agent 310:
What information does agent 310 need to obtain from subject 202?
What sensors can obtain that information?
Are there multiple sensors that can be implemented to measure the same human state to increase the accuracy and reliability of predictions?

Once data are collected from the sensors 230, intelligent agent 310 can interpret the data captured by sensors to draw an intelligent conclusion. This is accomplished following the principles of signal detection theory (SDT). SDT explains an approach for identifying signals, or, in context, human states that are sufficient to initiate a response from the SPECIES agent. For example, if intelligent agent 310 “hears” the word “yes” to a question, the agent will detect that the “yes” signal is present and render an appropriate response to the human's answer. Or, if intelligent agent 310 detects an increase in pupil dilation, the agent could determine the signal of “familiarity” is present and render an appropriate response to this familiarity.

Intelligent agent 310 can determine that a signal is present when a decision variable for the signal is greater than a specified threshold (known as the criterion or decision criterion). The decision variable refers to the measures obtained from sensors 202 (e.g., vocalic measures, pupil diameters, vital signs, linguistic measures), which are captured and then represented in numeric format.

Importantly, although a decision variable value might be greater than the decision criterion, it may not mean a signal is present and vice versa. For example, although a SPECIES agent might automatically transcribe the word “yes” as an answer to a question, the human might have said a similarly sounding word, such as “guess.” An increased reading in pupil dilation might be due to an instrument calibration error rather than familiarity. This is consistent with popular interpersonal communication theory that claims “noise,” or error, can and will interfere with decoding and interpreting information.

In signal detection theory (SDT), a decision variable reading that is not a signal in reality is also referred to as noise. Both signal decision variables and noise decision variables are normally distributed and are referred to as the signal distribution and noise distribution accordingly.

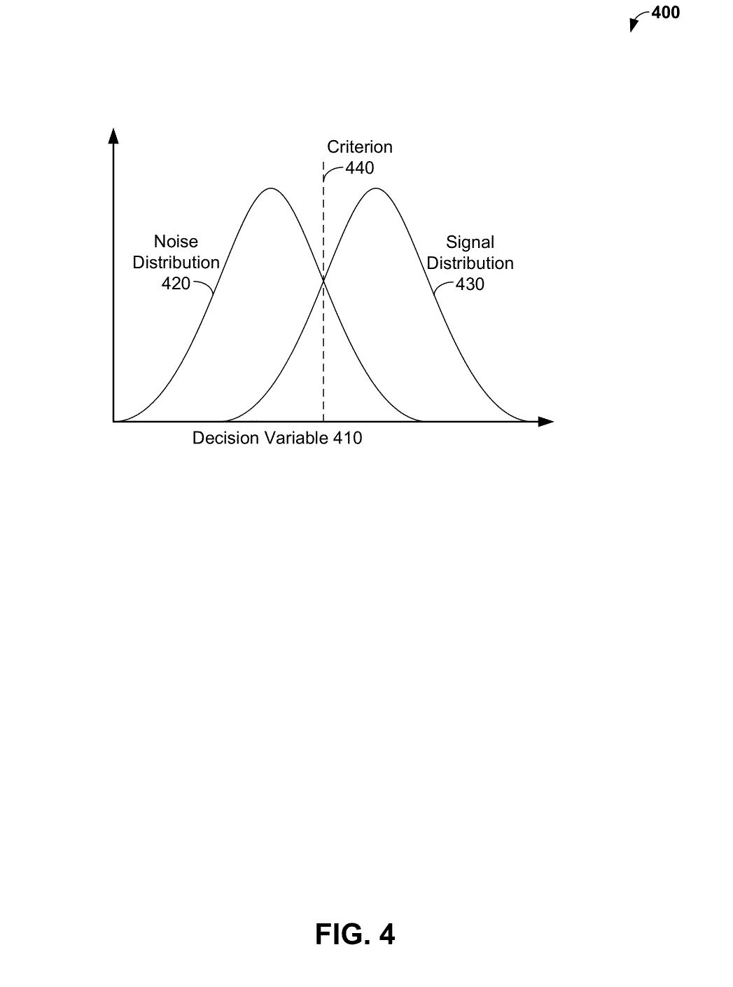

FIG. 4 is an example graph 400 showing a decision variable 410 along an X axis and plots of noise distribution 420 and signal distribution 430 functions with a decision criterion 440. In SDT terminology, for intelligent agent 310 to correctly interpret sensor information from sensors 230, decision criterion 440 of FIG. 4 should be placed accurately. For example, how does intelligent agent 310 know what psychophysiological indicators (e.g., pulse, eye gaze, fidgeting) indicate arousal in a human, and at what point do those indicators merit a response from intelligent agent 310? To address this, machine learning algorithms can be utilized to determine placement of decision criterion 440 for use by intelligent agent 310. Machine learning refers to algorithms that allow a computer to evolve behaviors based on empirical data, such as sensor data from the SPECIES agent.

Machine learning algorithms can be described using two paradigms—supervised learning and unsupervised learning. Supervised learning refers to algorithms that take training examples with input/output pairs and learn how to predict the output values of future data. For example, intelligent agent 310 that is trying to detect arousal from heart pulse (obtained unobtrusively through a Laser Doppler Vibrometer) can learn how to predict of arousal outputs using training data that contains 1) a heart pulse reading and 2) whether or not the person was aroused. Using this information, response classification algorithm(s) 322 can identify patterns and boundaries (i.e., criteria) that predict arousal, which can be used to categorize future data. To predict sophisticated outcomes (e.g., confidence, deception, boredom, etc.) data from many simultaneous sensor streams have to be incorporated into response classification algorithm(s) 322 to make an accurate prediction. Examples of supervised learning algorithms include: support vector machines, artificial neural networks, Bayesian statistics, ID3 and C4.5 decision tree building algorithms, Gaussian process regression, statistical techniques, and naive Bayes classifiers.

Unsupervised learning refers to algorithms that take input training examples without an output value (data that has not been previously categorized). Using this data, the algorithms uncover patterns to predict output values. These can be used to create categorizations of people. For example, not all people will interact with a particular SPECIES agent in the same way; some people have computer anxiety, some people find it difficult to attribute credibility to computers, and so forth. A priori, it can be very difficult to create these categories, as many categories could exist. However, using a self-organizing map as response classification algorithm 322, categories of people can be created automatically from data based on how people respond to the system. Intelligent agent 310 can further customize responses to people based on these categories. Examples of unsupervised learning algorithms include: neural network models, self-organizing maps, and adaptive resonance theory.

Intelligent agent 310 can encode a response to the human user based on the interpretation of sensor data. Intelligent agent 310 can respond to humans using user interface/embedded conversational agents 220 and output speech, all of which can be conveyed in one or more avatar communications 340. Intelligent agent 310 can use one or more of the virtual actors discussed above in the context of Table 1 to provide avatar communications 340 to subject 202.

Intelligent agent 310 can use persuasion to successfully convey a response to a human, such as subject 202. Intelligent agent 310 can affect the environment by delivering persuasive messages and exhibiting persuasive behavior. To help address this need, frameworks of persuasive technology can be adapted for use by intelligent agent 310.

These frameworks help system designers generate precise requirements for system qualities that promote persuasive human-computer interactions based on four persuasive design principles: primary task support, dialog support, system credibility support, and social support. Intelligent agent 310 can be designed to incorporate these persuasive technology design principles.

The first category of persuasive design that can improve the persuasiveness of systems is primary task support. Primary task support refers to the measures taken to aid the user in carrying out his or her primary task for using the system. Its influence on persuasion can be explained through at least two mechanisms: 1) through creating positive affect (i.e., to be or create a positive influence) and 2) through reducing biases and increasing cognitive elaboration. First, primary task support increases positive affect. When a system supports the user in completing his or her goal with the system (e.g., through reduction, tunneling, self-monitoring, simulation, and rehearsal), this increases the cost-benefit ratio of using the system, resulting in positive affect. Positive affect successfully yields an increase in the persuasiveness of the source because, when deciding whether or not to be persuaded by a system, users subconsciously ask themselves, “how do I feel about it?” and thus affect influences their judgment. In summary, positive thoughts increase confidence in the target.

Table 4 below includes several example primary task support design principles that can influence persuasion.

TABLE 4

| Systems | |
|---|---|
| Design Principle | Description |
| Reduction | Reduce complexity of a behavior into simpler tasks |
| Tunneling | Guide user through experience |
| Tailoring | Meet the needs, interests, personality, and |
| | usage context of user |
| Personalization | Personalize context |
| Self-monitoring | Keep track of user's progress in accomplishing goal |
| Simulation | Show the link between cause and effect |
| Rehearsal | Rehearse the behavior in the real world |

Dialog support entails providing feedback to users. This can happen via sounds, words, graphics, and many other forms of media. Dialog support has been robustly shown to influence the persuasiveness of systems. This increase in persuasion is a function of people subconsciously asking themselves “how they feel about the message,” and in doing so they attribute the positive affect to their judgment of confidence. For example, feedback, suggestions, and expressions can improve the persuasiveness of a system by improving the clarity and correctness of one's attitude toward the message. Positive dialog support (e.g., praise and reward) can promote positive affect or feelings, which can influence users' confidence in the source. Negative feedback, suggestions, and expressions can also be very persuasive. For example, exchange, coalition, legitimization, and pressure tactics can influence the persuasiveness of a source. These tactics increase cognitive elaboration, which increases persuasion in response to strong arguments.

In the context of intelligent agent 310, impression management tactics can be particularly effective and easy-to-implement dialog support techniques to improve persuasion. Table 5 below provides several example dialog support system design principles that can influence persuasion.

TABLE 5

| Systems Design Principle | Description |
|---|---|
| Praise | Offer praise through words, sounds, |
| | images, etc. |
| Rewards | Reward the user based on |
| | performance |
| Reminders | Remind user of goals |
| Suggestion | Offer fitting suggestions |
| Social Role | Adopt a social role |

Credibility can be closely related to believability. The influence of credibility on persuasion has been the root of several theories of interpersonal persuasion, such as Source Credibility Theory, and has been shown to be an important element of system persuasiveness. It is a multidimensional construct that directly and indirectly influences persuasion.

When users view an information system as credible, they are more persuaded that the system's message is true. This degree of credibility can be influenced by the system's appearance, real-world feel, and surface credibility. This occurs because positive credibility “primes” other positive thoughts in the brain, making them easier to recall, thus influencing a user's judgment. Credibility can also be transferred to a system through branding, third-party endorsements, or referring to people with power. This transferring of credibility is an effective way to increase persuasion. For persuasion to occur, a perceived link between the parties is to be established and similarity shown between the source and target

Credibility can be manipulated through a number of design decisions. For example, credibility is influenced by the competence, character, sociability, composure, and extrovertedness of the intelligent agent. The demeanor, gender, ethnicity, hair color, clothing, hairstyle, and face structure of the agent can manipulate these characteristics. One study of embodied agents in a retail setting found a difference in gender preferences. Participants preferred the male embodied agent and responded negatively to the accented voice of the female agent. However, when cartoonlike agents were used, the effect was reversed and participants liked the female cartoon agent significantly more than the male cartoon.

Emotional demeanor is an additional signal that can be manipulated to influence the credibility of intelligent agent 310. The emotional state display may be determined from the probability that desired goals will be achieved. Emotions can be expressed through the animated movements and facial expressions, which may be probabilistically determined based expert system 320. There are many possible renderings that can influence human perception and affect the agent's operating environment. For example, SPECIES system 200 can include full physical representations, or just a part of the body such as a head and face, such as discussed above in the context of Table 1. Table 6 summarizes how establishing credibility can be incorporated into system design.

TABLE 6

| Systems Design | Description |
|---|---|
| Trustworthiness | Provide unbiased, fair, and truthful information |
| Expertise | Show information portraying knowledge, |
| | expertness, and competence |
| Surface Credibility | Display a competent look and feel |
| Real-world feel | Provide information of real organization and people |
| | behind the |
| Attractiveness | Be visually appealing to the user |
| Authority | Refer to people of authority or act authoritative |
| Third-part | Show endorsements from respected third parties |
| endorsements | |
| Variability | Provide a means to validate accuracy |

Social support refers to leveraging social influence to persuade people. Social influence refers to a change in an attitude or behavior that is caused by another person and how one views his or her relationship to the other person and society in general. Social influence can be described as peer effects and can be intentional or unintentional (Asch, 1965).

Social support can influence persuasion because people seek favorable evaluations of themselves as well as insurance about satisfactory relations with others. When users see others using the system, and when the system allow users to compare the outcome of their interaction with other users' outcomes, they will feel pressured to conform their attitude to the attitude of the other users. For example, if prior to interacting with a SPECIES agent, such as intelligent agent 310, one has observed other users interacting with the system, and these other users have been satisfied with the feedback, one's evaluation of intelligent agent 310 will more likely be anchored and skewed toward the other users' positive evaluations. Table 7 demonstrates how a system can persuade through leveraging social support.

TABLE 7

| Systems Design Principle | Description |
|---|---|
| Social Learning | Show others using the system and the outcomes |
| Social Comparison | Provide means for users to compare outcomes |
| Normative Influence | Provide means to gather people together |
| | with similar goals |
| Social Facilitation | Provide means for discerning other users |
| Cooperation | Facilitate cooperation |
| Competition | Facilitate competition |
| Recognition | Give public recognition |

In other embodiments, speech tree 324 can include a number of questions, where each question can be expressed in two or more languages. Intelligent agent 310 can determine a language of subject 202, based on specific input from subject 202 and/or identifying the language from an excerpt of speech included in response 350 to avatar communication 340 or another except of speech from subject 202.

### Using Gender and Demeanor as Effectors of a SPECIES Agent

Varying embodied gender and demeanor can affect human perception. There are myriad possibilities for creating an embodied appearance for the intelligent agent, and so this study focuses on how gender and demeanor may affect perceptions of the agent's power, trustworthiness, likability, and expertise. In some embodiments, a SPECIES agent can have two different embodied genders (male and female) and two different demeanors (neutral and smiling). Different aspects of the SPECIES agent can be changed to more appropriately use these embodied instantiations as effectors to accomplish its goals. For example, if a male avatar is perceived as more powerful, the SPECIES agent can use a male avatar given an airport screening context. On the other hand, if a smiling female avatar is perceived as more likable, the SPECIES agent can use a smiling female avatar when trying to generate trust or provide assistance and recommendations.

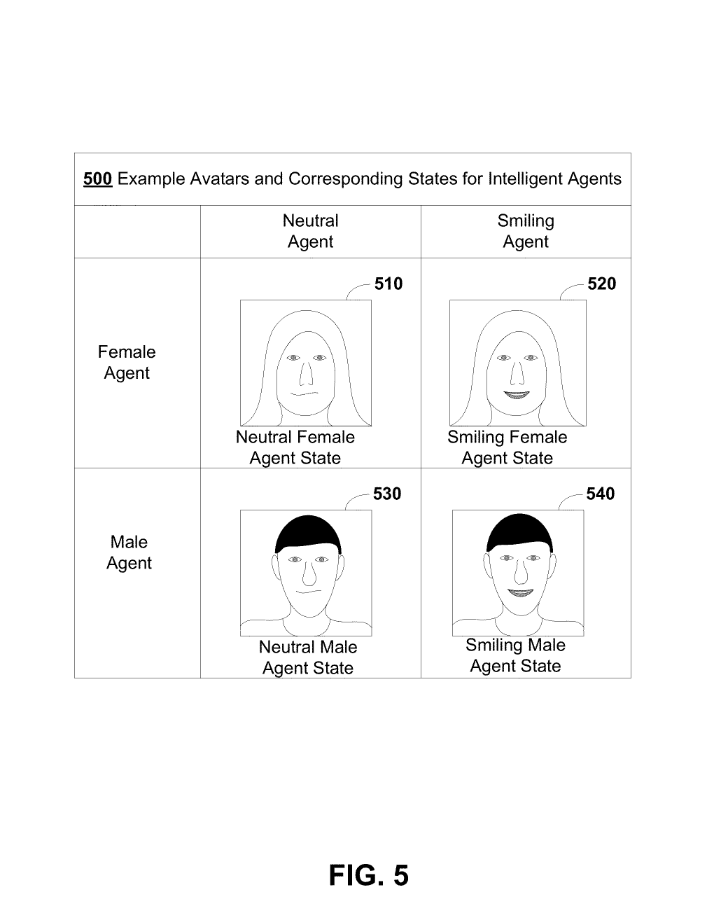

FIG. 5 shows a state table 500 with corresponding avatars 510, 520, 530, 540 for intelligent agents. In some embodiments, at least two aspects of a SPECIES agent, such as intelligent agent 310, can be selected: gender, as either male or female, and demeanor, as either neutral or smiling. Given those two aspects of SPECIES agents, state table 500 shows possible states and example avatars corresponding to each possible state. For example, if a SPECIES agent's gender is selected to be female, and the SPECIES agent's demeanor is selected to be neutral, the agent can be said to be in the “Neutral Female Agent” state and utilize avatar 510 for agent/human interaction. Similarly, if a SPECIES agent's gender is selected to be female, and the SPECIES agent's demeanor is selected to be smiling, the agent can be said to be in the “Smiling Female Agent” state and utilize avatar 520 for agent/human interaction.

As other examples, if a SPECIES agent's gender is selected to be male, and the SPECIES agent's demeanor is selected to be neutral, the agent can be said to be in the “Neutral Male Agent” state and utilize avatar 530 for agent/human interaction. Similarly, if a SPECIES agent's gender is selected to be male, and the SPECIES agent's demeanor is selected to be smiling, the agent can be said to be in the “Smiling Male Agent” state and utilize avatar 540 for agent/human interaction. In other embodiments, more, fewer, and/or different aspects of avatars and states of SPECIES agents can be selected, and corresponding state tables and corresponding avatars can be selected and used.

As shown in FIG. 3, intelligent agent 310 has a script tree 324 and can include a state representation as part of response classification algorithms 332 to track of the context of the current interaction. In some embodiments, intelligent agent 310 initializes the available gender/demeanor states shown in FIG. 5 and randomly selects a gender/demeanor state for initial use. Intelligent agent 310 can then ask a number of questions (e.g., four) different questions, and following this interaction agent 310 solicits a user or human subject for feedback of their perception of agent 310. Agent 310 can then chooses another gender/demeanor state from state table 500, asks a number of additional questions, solicits feedback, and repeat the process. A presurvey completed by participants before interacting with intelligent agent 310 can be used to provide data for adapting of agent/human interaction depending on the individual traits of the human subject and responses during the interaction.

In some embodiments, a number, e.g., four, of animated models can be used. FIG. 5 shows examples of images of models as avatars 510, 520, 530, and 504. Both the male and female models can have similar facial structures and can be identical in size, volume, and background Skin color, eye color, and facial shape can be essentially the same between the two models. After the models were created, voice recordings for the models can be created. For example, a female and a male actor can record a number, e.g., sixteen, different questions that simulated an airport screening environment. The voice recordings were then used in conjunction with the animated models, where each recorded question was stored as a separate animated clip. Each of the animated models use the same head movements and blink rates; e.g., 22.5 blinks per minute. Each animated model also had a silent clip used when the agent expected responses from human subjects. Transitions between animated clips were seamless, and changes to the embodied state only occurred after soliciting interaction feedback.

Choice of avatar gender and demeanor may have effectiveness and public relations consequences. One of the four gender/demeanor states discussed above was selected for use by an intelligent agent 310. The agent then asked the screening questions and waited naturally for participants to respond. The perceptions of people being questioned can influence what responses are elicited by the agent and therefore affect the quality of cues that the sensors can detect. For example, if a person perceives high expertise, trustworthiness, credibility, and power of intelligent agent 310, the person will likely respond to the kiosk seriously. Conversely, it is possible that if intelligent agent 310 is intimidating, those harboring malicious intent may reveal contempt, anger, or fear to a greater extent than those with benign intent. Moreover, foreign travelers' perceptions of intelligent agent 310 can affect the travelers' first impressions of the United States when passing through a port of entry.

Before interacting with intelligent agent 310, human subjects completed a survey that captured basic demographic information indicated in FIG. 3 as survey data 360. When they arrived at the experiment, the human subjects signed a consent form and then were instructed to pack a bag of various items on a table to take through a screening checkpoint. After the subjects packed their bag, they approached a station for intelligent agent 310, where the intelligent agent 310 was waiting to ask them questions.

The agent/human interaction began when the participant pushed the button on a mouse placed in front of the station. Agent 310 then asked the first question in script tree 324, activated sensors 230, as both video and audio sensors were controlled by agent 310, and waited while the human subject responded to the question. The human subjects provided their responses via vocalized speech and pressed the mouse button when they had finished answering the question.

After asking four different questions using the selected gender/demeanor state, intelligent agent 310 solicited the human subject for feedback as to their perception of the intelligent agent 310. Intelligent agent then chose another gender/demeanor state and asked four more questions and repeated the process, until all gender/demeanor state were utilized to ask a total of sixteen questions. The same sixteen questions were asked in the same order every time, but the gender/demeanor state was randomly assigned. Thus, each human subject interacted with an agent having each gender/demeanor state. The questions are shown in Table 8 below.

TABLE 8
First Block of Questions:
Please describe in detail the contents of your backpack or purse.
I am detecting deception in your responses. Please explain why that is.
What will you do after you get through this checkpoint?
Please tell me how you have spent the last two hours before coming
to this checkpoint.
Second Block of Questions:
Has anyone given you a prohibited substance to transport through this
checkpoint?
Why should I believe you?
What should happen to a person that unlawfully takes prohibited
substances through a checkpoint?
Please describe the last trip or vacation that you took.
Third Block of Questions:
Do any of the items in the bag not belong to you? If so, please describe
which items those are.
How do you feel about passing through this checkpoint?
Please elaborate on why you feel that way.
Based on your responses, the previous screeners have detected that
you are nervous.
Please explain why that is.
Fourth Block of Questions:
Are there any of your responses that you would like to change? If so,
please describe what they are.
Is there anything that you should have told us but have not?
How do you think that our assessment of your credibility will work out for
you today?
Why do you think that?

Prescriptive stereotypes can be used to understand how participants would be affected by the different embodied genders and demeanors of intelligent agent 310. A prescriptive stereotype affects perceptions of how a person should be, and the theory states that qualities that are ascribed to women and men also tend to be the qualities that are required of men and women. Given the experimental setup, where an agent is in a pseudo position of authority (asking questions about the contents of a bag), and the nature of prescriptive stereotypes, several embodied gender-based hypotheses were developed as shown in Table 9A below:

TABLE 9A
Hypothesis 1: Male embodied models cause the agent to be perceived as
more powerful than female embodied models.
Hypothesis 2: Male embodied models cause the agent to be perceived as
more trustworthy than female embodied models.
Hypothesis 3: Male embodied models cause the agent to be perceived as
more expert than female embodied models.
Hypothesis 4: Female embodied models cause the agent to be perceived
as more likable than male embodied models.

Some studies have found that changing an avatar's demeanor through facial expression changed perceptions of an avatar's credibility. Similarly, other studies found that agent facial features were able to affect perceptions of likability. Based on the findings of the previous studies, and the current context, the following demeanor-based hypotheses were develop as shown in Table 9B below:

TABLE 9B
Hypothesis 5: Neutral demeanors cause the agent to be perceived as more
powerful than smiling demeanor models.
Hypothesis 6: Smiling demeanors cause the agent to be perceived as more
trustworthy than neutral demeanor models.
Hypothesis 7: Neutral demeanors cause the agent to be perceived as more
expert than smiling embodied models.
Hypothesis 8: Smiling demeanors cause the agent to be perceived as more
likable than neutral demeanor models.

After each interaction with a selected gender/demeanor embodiment of intelligent agent 310, the participants responded to a brief questionnaire to measure their perception of the agent based on dependent measures. The dependent measures include 26 semantic differential word pairs as shown in Table 10 below that rate the participant's perceptions of the agent's power, composure, trustworthiness, expertise, and likability. These items have been replicated with high reliability in studies related to source credibility and perceptions of power.

TABLE 10

| | |
|---|---|
| Construct | Semantic Differential Word Pairs |

| | | |
|---|---|---|
| Power | Weak | Powerful |
| | Submissive | Dominant |
| | Lacking confidence | Confident |
| | Non-influential | Influential |
| | Low Status | High Status |
| Composure | Tense | Relaxed |
| | Anxious | Calm |
| | Nervous | Poised |
| | Uncomposed | Composed |
| | Uncertain | Certain |
| Trustworthiness | Undependable | Dependable |
| | Dishonest | Honest |
| | Unreliable | Reliable |
| | Insincere | Sincere |
| | Untrustworthy | Trustworthy |
| Expertise | Unknowledgeable | Knowledgeable |
| | Unqualified | Qualified |
| | Unskilled | Skilled |
| | Uninformed | Informed |
| | Incompetent | Competent |
| Likability | Unfriendly | Friendly |
| | Uncheerful | Cheerful |
| | Unkind | Kind |
| | Unpleasant | Pleasant |
| | Unattractive | Attractive |
| | Dissimilar to me | Similar to me |

In an experiment, 88 human participants interacted with intelligent agent 310. Most of the participants came from a medium-size city in the southwestern United States. The mean age of the population was 25.45 years (standard deviation [SD]=8.44). Fifty-three of the participants were male and 35 were female. Eighty-five of them spoke English as their first language. Because a within-subject design was used, each participant rated all four embodied instantiations, resulting in 352 agent ratings of 26 items each.

Each participant rated four different avatars in a within-subject design, traditional factor analysis, which assumes independence of observations, may be inappropriate. To account for clustering within participants, a total correlation matrix of perception measures was partitioned into separate within- and between-subject matrices. The within matrix was then submitted to a multilevel factor analysis using the maximum likelihood method and geomin oblique factor rotation. The semantic differential pairs were coded on a scale from 1 to 7, and a four-factor solution corresponding to power, trustworthiness, expertise, and likability was extracted from the within-sample correlation matrix with eigenvalues of 6.49, 3.95, 1.03, and 0.92 (x²(62)=119.4, p<0.01, comparative fit index [CFI]=0.981, root mean square error of approximation [RMSEA]<0.01). The CFI and RMSEA statistics suggest a moderately good fit. Table 11 below displays the factor loadings for the within-sample correlation matrix for the five constructs listed in Table 10: power, composure, trustworthiness, exnertise, and likability.

TABLE 11

| | | Com- | | Exper- | |
|---|---|---|---|---|---|
| Item | Power | posure | Trustworthiness | tise | Likeability |
| PWWEAK | 0.75 | | | | |
| PWDOM | 0.79 | | | | |
| PWCONF | 0.75 | | | | |
| PWINF | 0.71 | | | | |
| PWSTATUS | 0.22 | 0.28 | | | 0.29 |
| CMTENSE | | 0.50 | | 0.59 | |
| CMCALM | | 0.63 | | 0.31 | |
| CMNERV | | 0.75 | | | |
| CMCOMP | | 0.54 | 0.25 | | |
| CMCERT | 0.24 | 0.28 | 0.49 | −0.19 | |
| TRDEP | | | 0.61 | | |
| TRHON | | | 0.90 | | |
| TRREL | | | 0.86 | | |
| TRSIN | | | 0.38 | 0.42 | |
| TRTRUST | | | 0.50 | | 0.35 |
| EXKNOW | | | | | 0.62 |
| EXQUAL | | | | | 0.71 |
| EXSKILL | | | | | 0.95 |
| EXINFO | | | | | 0.69 |
| EXCOMP | | | | | 0.73 |
| LKFRIEND | | | | 0.89 | |
| LKCHEER | | | | 0.90 | |
| LKKIND | | | | 0.92 | |
| LKPLEAS | | | | 0.88 | |
| LKATIR | | | | 0.50 | 0.31 |
| LKSIM | | | | 0.51 | 0.28 |

The above constructs and word-pairs shown in FIG. 5 were analyzed and some constructs and word-pairs discarded. The power word-pair measuring status was removed because of weak cross-loadings, as it is likely that status was not relevant in this experiment. Nearly all of the word pairs measuring composure cross-loaded and were removed. Two of the word pairs of trustworthiness cross-loaded with likability and expertise and were excluded. All the expertise measures were found to be valid in this experiment, and four of the likability measures were also included. The final measures; i.e., constructs and word-pairs, used for generating results are shown in Table 12 below.

TABLE 12

| | |
|---|---|
| Construct | Semantic Differential Word Pairs |

| | | |
|---|---|---|
| Power | Weak | Powerful |
| | Submissive | Dominant |
| | Lacking confidence | Confident |
| | Non-influential | Influential |
| Trustworthiness | Undependable | Dependable |
| | Dishonest | Honest |
| | Unreliable | Reliable |
| Expertise | Unknowledgeable | Knowledgeable |
| | Unqualified | Qualified |
| | Unskilled | Skilled |
| | Uninformed | Informed |
| | Incompetent | Competent |
| Likability | Unfriendly | Friendly |
| | Uncheerful | Cheerful |
| | Unkind | Kind |
| | Unpleasant | Pleasant |

The final constructs of power (a=0.88), trustworthiness (a=0.87), expertise (a=0.94), and likability (a=0.95) were found highly reliable. Given the high reliability of each measure, mean composites were computed for each of the final perception measures.

### Results Related to Gender-Based and Demeanor-Based Hypotheses

Repeated-measures ANOVA (analysis of variance) were conducted, specifying the within factors (participant, embodied model gender, and embodied demeanor). Participant gender is included as a between factor. A significant main effect was found for the embodied model gender for perceptions of the SPECIES agent power.

Regarding the four gender-based hypotheses shown in Table 9A above, the male embodied models were perceived by participants as more powerful (F(1,86)=52.84, p<0.001), supporting Hypothesis 1. The male embodied models were also perceived as more trustworthy, which lends support to Hypothesis 2 (F(1, 86)=3.464, p<0.05, one-tailed). This relationship for perceived trustworthiness was similar to the finding for perceived expertise. The male embodied models, in this experiment, created a greater perception of expertise than the female embodied models. Therefore, Hypothesis 3 received support (F(1, 86)=4.2147, p<0.05). As for the last gender-based hypothesis, as predicted by the prescriptive stereotype literature, female models were perceived as more likable. Hypothesis 4 received significant support (F(1, 86)=29.654, p<0.001).

Regarding the four demeanor-based hypotheses shown in Table 9B above, neutral demeanor embodied agents were perceived as the most powerful, lending support to Hypothesis 5 (F(1,86)=5.1626, p<0.05). However, Hypothesis 6 was discredited and did not receive support. Specifically, smiling embodiments were not perceived as more trustworthy (F(1,86)=0.777, p<0.4). Similarly, Hypothesis 7 did not receive support. Demeanor did not significantly change perceptions of expertise (F(1, 86)=0.63, p<0.5). Finally, Hypothesis 8 was strongly supported. Smiling embodied agents were perceived as more likable than neutral agents (F(1, 86)=36.781, p<0.001) (shown in FIG. 13). Table 13 summarizes the hypotheses and results from this experiment.

TABLE 13

| Hypothesis | Result |
|---|---|
| Hypothesis 1: Male embodied models cause the | Supported with |
| agent to be perceived as more powerful than female | p < 0.001 |
| embodied models. | |
| Hypothesis 2: Male embodied models cause the | Supported with p < |
| agent to be perceived as more trustworthy than | 0.05, one-tailed |
| female embodied models. | |
| Hypothesis 3: Male embodied models cause the | Supported with |
| agent to be perceived as more expert than female | p < 0.05 |
| embodied models. | |
| Hypothesis 4: Female embodied models cause the | Supported with |
| agent to be perceived as more likable than male | p < 0.001 |
| embodied models. | |
| Hypothesis 5: Neutral demeanors cause the agent to | Supported with |
| be perceived as more powerful than smiling | p < 0.05 |
| demeanor models. | |
| Hypothesis 6: Smiling demeanors cause the agent | Not supported |
| to be perceived as more trustworthy than neutral | |
| demeanor models. | |
| Hypothesis 7: Neutral demeanors cause the agent | Not supported |
| to be perceived as more expert than smiling | |
| embodied models. | |
| Hypothesis 8: Smiling demeanors cause the agent | Supported with |
| to be perceived as more likable than neutral | p < 0.001 |
| demeanor models. | |

This experiment indicates that the SPECIES agent can manipulate its embodied models in order to affect individuals' perceptions of the system. The hypotheses based on gender manipulations were confirmed to have a consistent effect. Throughout this experiment, the same questions were asked the same way and in the same order every time, and the voice was also identical despite demeanor. The demeanor manipulations may not have been as effective in this experiment as compared to other studies because of the nature of the task. In this study, the person is being interviewed and the agent is not trying to persuade or “partner” with the participant. It is almost an adversarial interaction with intelligent agent 310 asking questions and the person answering.

### Using Voice to Detect Stress

In order to affect and interact with humans, a SPECIES agent, such as intelligent agent 310, primarily uses sensors to sense its environment. Beyond just sensing the environment, the SPECIES agent can make intelligent decisions based on these sensors. A vocal sensor—e.g., a microphone measuring vocal signals—can be used to detect the emotion of humans in a rapid screening-type interaction. The vocal sensor can in included in a kiosk; e.g., the vocal sensor can act as microphone 120 in kiosk 100 discussed above in the context of FIG. 1.

The SPECIES agent can use an emotional-detection model developed in this study to detect human emotion. The emotional-detection model uses standard and scientific vocalic measures that can be interpreted and replicated, and includes only measurements that the SPECIES agent could feasibly sense from the environment on its first interaction with a human. The developed emotional-detection model is based on vocal data collected from participants who were instructed to lie or tell the truth to a set of neutral or stressful questions.

In an experiment, two hundred twenty participants were interviewed and compensated $15. They were offered an additional $20 if they could convince the interviewer of their credibility. Eighteen participants were disqualified for not following directions. Because of differences in recording equipment, high signal-to-noise ratio in the environment, and poor audio quality, only 81(44 men, 37 female) of the 202 valid participants were included in this study. Because a within-subjects design was used, this resulted in 760 vocal observations.

An emphasis was placed on recruiting international participants to achieve a culturally diverse sample. Of the 81 participants, 31.6 percent were born in a country other than the United States. The percentage of observations by country is detailed in Table 14:

TABLE 14

| Country | Percent |
|---|---|
| United States | 68.4 |
| India | 9.3 |
| Korea | 3.8 |
| Ukraine | 3.0 |
| Iran | 1.7 |
| Ireland | 1.7 |
| Mexico | 1.7 |
| Pakistan | 1.6 |
| South Africa | 1.6 |
| South Korea | 1.6 |
| Bangladesh | 1.4 |
| Brazil | 1.4 |
| Germany | 1.3 |
| Italy | 1.2 |
| Kazakhstan | 0.1 |

In addition, 26.6 percent reported that English was not their first language. The mean age was 26.6 (SD=12.2) and ranged from 18 to 77 years. Participants reported ethnicities as 59.6 percent Caucasian, 22 percent Asian, 5.8 percent African American, 8.4 percent Hispanic, and 4.2 percent “other.”

Upon arrival at the experimental site, participants completed a consent form and a questionnaire that measured pre-interaction goals and demographics. They were informed that in an upcoming interview, they would be instructed to answer some questions truthfully and some deceptively, and that their goal was to convince the interviewer of their credibility and truthfulness. Success in doing so would earn them the bonus payment.

They then joined the interviewer, a professional examiner, in a separate room equipped with multiple sensors and a teleprompter that was hidden from the interviewer's view. The teleprompter instructed the participant to tell the truth or lie on each of the questions. In front of the participant was a unidirectional microphone recording their audio responses. Of interest to the current experiment are thirteen questions, intended to elicit brief, one-word answers, listed in Table 15 below.

TABLE 15
Initial Questions (N = neutral question, C = charged question)

| | |
|---|---|
| 1. | Is today Sunday? (N) |
| 2. | Are there any lights on in this room? (N) |
| 3. | Where were you born? (N) |
| 4. | Did you ever take anything from a place where you worked? (C) |
| 5. | Did you bring any keys with you today? (C) |
| 6. | If I asked you to empty your wallet/purse/backpack, would anything |
| | in it embarrass you? (C) |
| 7. | Is the door closed? (N) |
| 8. | Are you now sitting down? (N) |
| 9. | What city did you live in when you were 12 years old? (N) |
| 10. | Did you ever do anything you didn't want your parents to know |
| | about? (C) |
| 11. | Name the country stamped most often in your passport? (N) |
| 12. | Did you ever tell a lie to make yourself look good? (C) |
| 13. | If I told you I didn't believe you, would that bother you? (C) |

The questions listed in Table 15 reflect a typical interaction during a rapid screening at an airport or security checkpoint. The emphasis on short responses made the vocal measurements more comparable within and between participants.

To counterbalance truth and deceit, participants were randomly assigned to one of the following sequences (deception=D and truth=T):

Sequence One: DT DDTT TD TTDD T
Sequence Two: DT TTDD TD DDTT T

The questions listed in Table 15 often elicit short, one- to two-word answers and are designed to be either charged (e.g., stressful) or neutral. Neutral questions such as “Where were you born?” and “What city did you live in when you were 12 years old?” were meant to be straightforward questions devoid of any emotion or stress. In contrast, stress questions such as “Did you ever take anything from a place where you worked?” and “Did you ever do anything you didn't want your parents to know about?” were intended to evoke enhanced emotional responses because of the implications of the answer. For instance, saying that you stole something from a place where you work is normatively inappropriate and should induce more stress or cognitive effort in the response as compared to neutral questions. Of the 13 questions, only 8 of the questions varied the lie and truth condition between participants. Following the interview, the participants completed post-interview measures and were debriefed while the interviewers recorded their assessments of interviewee truthfulness and credibility.

All the participant recordings, captured as 48 kHz mono WAV files, were listened to in real time and manually segmented to mark the time points at the exact onset and offset of vocal responses to each of the 13 questions of Table 15. Commercial vocal analysis software was utilized to aid segmentation by isolating only voiced parts of the recordings during manual segmentation. The mean response length of each vocal measurement was 0.55 seconds (SD=0.45) and consisted primarily of one-word responses (e.g., “yes,” “no”). All the vocal recordings where then resampled to 11.025 kHz and normalized to each recording's peak amplitude. Vocal measurements used in this study were then calculated using the phonetics software Praat.

Previous research has found that people speak with a higher pitch and with more variation in pitch or fundamental frequency when under increased stress or arousal. However, there are many other factors that can contribute to variation in pitch. For instance, the words spoken can strongly influence the average pitch of an utterance because different phonemes or vowels emphasize higher or lower pitches. There is also variation between people who have different resonance characteristics, accents, language proficiency, gender, and intonation.

Pitch, the primary dependent measure of this study, was calculated using the auto-correlation method. The harmonics-to-noise ratio was calculated to serve as an indicator of voice quality. Originally intended to measure speech pathology, the harmonic-to-noise ratio is included to account for the unique speaking characteristics of different participants (measured in decibels with larger values reflecting higher quality). Vocal Intensity was calculated to partially control for the influence of different words and vowels. Vowels that require more open mouth and are used in words such as “saw” and “dog” result in an increase of 10 dB over the words “we” and “see”. Humans perceive a 10 dB increase in intensity as a volume four times as loud. The third and fourth formants were calculated and reflect the average energy in the upper frequency range reflecting specific vowel usage in speech. The fourth formant is regarded as an indicator of head size. In order to correct the third formant for the unique resonance characteristics of different speakers, it was divided by the fourth formant. This ratio of third to fourth formant was included to account for the effect high-frequency vowels have on overall pitch. In addition to the vocal measures, the participants' gender and whether they were born in the United States, spoke English as the first language, answered a stressful question, or lied were included. All the selected measures used in this study were meant to be representative of the dearth of individual differences variables that a SPECIES agent would have at an airport or border screen environment.

A multilevel regression model was specified (n=760) using mean pitch as the response variable, the vocal and individual measurements previously described as fixed effects, and Subject (n=81) and Question (n=13) as random effects. To reflect the repeated measures experimental design, all measurements in the model were nested within subject. The full emotional-detection model of pitch as a response variable for stress is reported in Table 16.

TABLE 16

| | | β |
|---|---|---|
| | | standard |
| Fixed effects | β | error |
| Intercept | −236.59* | 86.40 |
| Voice quality | 20.92* | 6.41 |
| Female | 42.35* | 12.25 |
| Stress question | 23.58* | 8.39 |
| Born in the United States | −66.65* | 18.15 |
| English first language | 38.51* | 19.43 |
| Lie | −18.14* | 8.35 |
| High-frequency vowels | 491.70* | 107.77 |
| Vocal intensity | 0.88 | 0.53 |
| Voice quality * Female | 3.34* | 0.83 |
| Voice quality * Stress question | −1.61* | 0.67 |
| Voice quality * Born in the United | 5.11* | 1.34 |
| States | | |
| Voice quality * English first | −3.67* | 1.41 |
| language | | |
| Voice quality * Lie | 1.37* | 0.66 |
| Voice quality * High-frequency | −34.25* | 8.86 |
| vowels | | |

Notes:
Models were fit by maximum likelihood estimate.
*p < 0.05.

To test if the specified emotional-detection model provides a significant improvement to the fit of the data, it was compared to an unconditional model using a deviance-based hypothesis test. Deviance reflects the improvement of log-likelihood between a constrained model and a fully saturated model. The difference in deviance statistics (12,256−7,865=4,391) greatly exceed the test statistic, x² (14, n=760)=36.12, p<0.001. Thus, the null hypothesis that the specified emotional-detection model does not fit the data can be rejected.

The emotional-detection model can explore the relationship between emotional states and vocal pitch. The factors manipulated to evoke emotional responses were the instructions to lie and the asking of stressful questions. To test the hypothesis that pitch is affected by whether participants were answering stressful questions or lying, a deviance-based hypothesis test was conducted and compared the full model against the full model with the fixed effects of lying and stressful questions removed. The inclusion of lying indicators and stress questions significantly improves the fit of the model to the data, X² (4, n=760)=177, p<0.001.

The average pitch for males was 128.68 Hz and for females was 200.91 Hz. Responding to stressful questions resulted in an increase of pitch, β=23.58, t(760)=2.80. In contrast, deceptive vocal responses had a lower pitch than truthful responses, β=−18.14, t(760)=−2.10. This may be because responding honestly was more stressful for participants in this study, particularly when the lies were sanctioned and inconsequential. In addition, being a native English speaker or born in the United States resulted in lower pitch. This might be explained by a lower anxiety when being interviewed in one's native language.

The significant interactions between voice quality (harmonics-to-noise ratio) and the measures in the model qualify the simple effects for predicting pitch. Specifically, when answering stressful questions, pitch decreases and voice quality increases, β=−1.61, t(760)=−2.42, and lying results in higher pitch as voice quality increases, β=1.37, t(760)=2.06.

To more fully understand voice quality, a multilevel regression was specified with Voice Quality as the response variable, stress as a fixed effect, and Subject (n=81) and Question (n=13) both modeled as random effects. Stress was measured after the interview when participants reported how nervous, flustered, relaxed, uneasy, and stressed they felt during the interview. These items, measured on a seven-point scale, were then averaged into a composite (α=0.89) measuring stress. Reported levels of stress predicted increases in Voice Quality, β=0.66, t(722)=2.92. A deviance-based hypothesis test comparing the model against the unconditional model revealed that stress provides a significant improvement to the fit of the data, X²(1, n=722)=739.31, p<0.001. In light of these results, it appears that both voice quality and pitch reflect how stressed a person feels while speaking

### “Bomb Maker” Field Testing of Gaze Tracking

A theory-driven “Bomb-Maker” experiment to test arousal and familiarity was used to investigate the use of gaze tracking, with 41 participants in the experiment. These participants included 30 European Union Border Guards and 11 MIS undergraduate students. The experimental data were collected using a straightforward two-treatment, between-group research design that required some participants to assemble a realistic, but not operational, improvised explosive device (IED). Participants in the first treatment—the control group—were in the non-bomb making condition and therefore completely unfamiliar with the IED. Participants in the second treatment group became familiar with a simulated bomb and the bomb-making materials and then actually assembled the device.

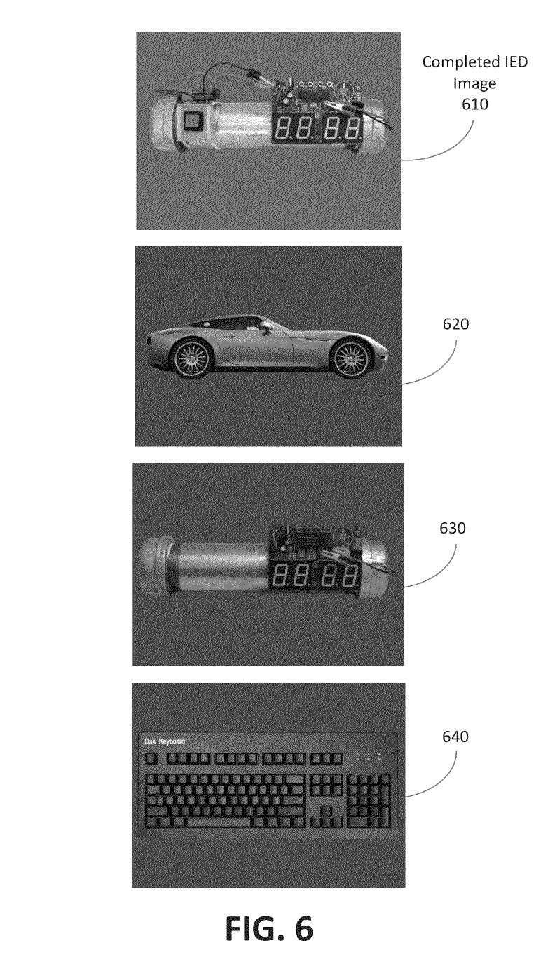

FIG. 6 shows images 610, 620, 630, 640 related to the Bomb-Maker experiment. Participants were randomly assigned to treatments, and the experiment participants in the bomb-making condition received the bomb-making materials and assembly instructions that included an image of the assembled bomb, shown on FIG. 6 as image 610. The instructions were as follows:

You will construct the IED pictured above with the materials provided to you. Follow the steps below in exact order to replicate the IED shown above.

Materials list:
Pipe
Timer
Battery
Switch
Zip ties

1. Orient the switch so the “1” is on the bottom. Firmly attach the switch to the left hand side of the pipe with two zip ties. Make sure the back of the switch is pressed against the white piece of Velcro already attached to the pipe. Make sure you don't break the switch module by tightening the zip ties too tight.

2. Attach the 9V battery to the 9V battery connector coming from the switch module.

3. Attach the Velcro on the 9V battery to the pipe above the switch module as shown in the picture. Make sure the connections on the battery are facing to the left (outward).

4. Orient the timer so the 4 digital numbers are at the bottom. Attach the timer to the pipe by placing the white Velcro on the back of the timer onto the black Velcro on the metal pipe. Position the right edge of the timer flush with the inside edge of the pipe cap.

5. Clip the red alligator clip coming out of the end of the pipe to the red wire coming out of the timer as shown above. Do the same with the black clip.

6. Clip the red alligator clip coming from the switch to the red wire coming from the left side of the timer as shown in the picture above. Do the same with the black alligator clip.

Participants took approximately 5-7 minutes to assemble the device. After the “bomb” was completed, participants packed a bag with clothes, shoes, and the IED and went to the SPECIES agent for screening. Those in the control group who did not construct an IED packed a bag with only clothes and shoes and then went directly to the SPECIES agent to begin the automated interview. At the station with the SPECIES agent, experiment personnel used a brief calibration program to calibrate the eye-tracking device to the participants' eyes. Then, the SPECIES agent communicated the following messages:
Please state your full name.
Are you a citizen of the United States?
Where are you travelling from?
What was your business there?
Do you have anything to declare?
Please carefully examine the following images . . .
   Images 620, 630, and 640 depicted in FIG. 6 were then displayed for 12 seconds each.
Have you ever seen a device similar to this image?
   Image 630 of FIG. 6 is displayed again.
Please see the officer at the next available station. Thank you for your cooperation.

The participants were then debriefed, dismissed, and the bomb was disassembled. The first and third images were used as basic foils and to allow for task acclimation. The key image of interest was image 630. Note that images 610 and 630 differ, as image 610 shows the IED that the participants assembled. Image 630 is the same IED, but the switch, battery, and connecting leads were removed to make this image novel to participants who assembled the device.

As previously mentioned, the images were shown for 12 seconds each. During that time, the participants' eyes were sampled at a rate of every ˜30 ms (33-34 samples per second). For each sample, the (x, y) gaze location on the screen (in pixels) and dilation for both eyes was captured; this six-tuple is denoted as below. The total number of samples for the participant is denoted by set P. Based on the image, screen size, and resolution, the region of interest was determined as any pixel on the x-axis less than 650 (the region where the switch was located). For every sample S, the average x coordinate was determined using the gaze position of each eye xₐₙ. Then, the gaze position was compared to a region of interest located near the on-off switch of the IED (shown on the left hand of the IED of image 610, but not shown in image 630).

The percentage of samples of gazes in the region of interest was determined for each participant. Using this metric, the mean percentage of time the control group gazed at the region of interest was 12.61% (SD=6.46%); whereas the mean time the IED-making group gazed at the region of interest was 28.82% (SD=13.67%). The participants in the bomb-making condition gazed much longer at the altered portion of the image. A Welch two-sample T-test shows that those in the aroused condition (bomb-making) viewed the image differently than those who were not familiar with the device (T=−4.956, df=30.853, p<0.001). The pupil diameter was also analyzed by comparing the dilation during the first image to the dilation during the second image, and found that those who built the bomb had a difference in pupil dilation almost twice as great as those that had not seen the bomb. The mean for the control group was 0.1139 mm (SD=0.1938 mm) while mean of the IED-making group was 0.2146 mm (SD=0.2119 mm.)

The functionality of interpreting data from sensors that can be incorporated into SPECIES agents, such as intelligent agent 310. Building on work about detecting familiarity with an IED using pupillometry, a binary decision tree for classification of familiarity based on gaze behavior and pupil changes was created. If the eye gaze duration was less than 23% in the area of interest and pupil diameter change was less than 0.28 mm, the participant was classified as in the control group, or not familiar with the IED.

Based on this classification model, the results showed an overall correct classification rate of 36 out of 41, or 87.8%. The classification matrix is shown in Table 17 below, where the “Bomb-Bomb” and “Control-Control” cells indicate correct classifications, and the “Bomb-Control” and “Control-Bomb” cells indicate incorrect classifications.

TABLE 17

| | Bomb | Control |
|---|---|---|
| Bomb | 20 | 3 |
| Control | 2 | 16 |

The experiment provided examples related to SPECIES agent design principles. First, in accordance with the first principle, the agent had a discrete context and “special purpose.” Second, the SPECIES agent controlled and managed a reciprocal interaction. Third, participant arousal and behavior were sensed by the infrared camera sensor and can be interpreted by the agent given the current context.

### “Bomb Maker” Field Testing for Vocalic Sensor Testing

A similar “bomb maker” field trial was conducted with a kiosk equipped with a microphone, such as kiosk 100 discussed above in the context of both FIG. 1 and in the section entitled “Using Voice to Detect Stress”. Intelligent agents executing on a computing device of kiosk 100 conducted rapid screening interviews with participants in a mock airport screening environment. All the participants packed baggage prior to their interview; however, some also assembled and packed a simulated bomb.

Twenty-nine EU border guards participated in a trial of several new border technologies. All of the participants spoke English during their interaction with the kiosk, but English was not their first language. The participants were all experienced in primary screening on the border of the respective countries Austria, Belgium, Estonia, Finland, France, Germany, Greece, Latvia, Malta, Netherlands, Norway, Poland, Romania, and Sweden. Of the 29 participants, 22 were male and 7 were female.

Participants were randomly assigned to either the Bomb Maker (n=16) or Control (n=13) condition. Participants in the Bomb Maker condition assembled a realistic, but not operational IED before packing the IED and an assortment of clothes in a travel bag, such as shown in images 610 and 630 of FIG. 6. In contrast, participants in the Control condition did not assemble an IED and only packed clothes in a travel bag. After packing their bags, all of the participants went directly to kiosk 100, in a separate room, for a rapid screening interview. All participants were instructed to successfully convince the intelligent agent of the kiosk of their credibility. However, only the male agent with the neutral demeanor, depicted as avatar 530, conducted the interviews because it was perceived as the most dominant and powerful. The participants completed a realistic interview that did not include any breaks as indicated in the discussion above of Table 8 to report their perceptions of the intelligent agent. The fifth question of Table 8, “Has anyone given you a prohibited item to transport through this checkpoint?” was of interest because it was likely to be the most stressful question for bomb makers. Only participants in the Bomb Maker condition would be lying and experiencing the extra concomitant stress and arousal during this question.

The vocal sensor was integrated into the kiosk and recorded all of the participants' responses. All the recordings were automatically segmented by the intelligent agent during the interview. The vocal recordings in response to the fifth question had a mean response length of 2.68 seconds (SD=1.66) and consisted of brief denials such as “no” or “of course not.” All the recordings were processed with the phonetics software Praat to calculate the vocal measurements for analysis.

An analysis of covariance (ANCOVA), between-subjects factor—condition (Bomb Maker, Control); covariates (Voice Quality, Gender, Intensity, High-Frequency Vowels)—revealed no main effects. All the participants had an elevated mean vocal pitch of 338.01 Hz (SD=108.38), indicating arousal and high tension in the voice. However, there was no significant difference in vocal pitch between the Bomb Maker and Control conditions (F(1,22)=0.38, p=0.54). In addition to mean vocal pitch, the variation of the pitch is also reflective of high stress or arousal.

A value that provides a measurement of vocal pitch variation is the standard deviation of vocal pitch. Submitting the measurement of vocal pitch variation to an ANCOVA revealed a significant main effect of the Bomb Maker condition (F(1, 22)=4.79, p=0.04). Participants in the Bomb Maker condition had 25.34 percent more variation in their vocal pitch than the Control condition.

TABLE 18

| Source | Sum of squares | Degrees of freedom | F |
|---|---|---|---|
| Voice quality | 36,887 | 1 | 23.27** |
| Gender | 12,434 | 1 | 7.85* |
| Bomb maker condition | 7,591 | 1 | 4.79* |
| High-frequency vowels | 4,412 | 1 | 2.78 |
| Vocal intensity | 19,269 | 1 | 12.16** |
| Error | 34,872 | 22 | |

*p < 0.05;
**p < 0.01.

Table 18 reports the summary of the analysis of covariance. Consistent with the results from Study 2, the covariates Voice Quality (F(1,22)=23.2°7,p<0.01), Gender (F(1,22)=7.85, p<0.01), and Intensity (F(1,22)=12.16, p<0.01) accounted for the additional variance in pitch variation owing to other factors such as linguistic content or word choice and accent.

This study begins to support the proof of value of a kiosk using an intelligent agent by integrating a vocal sensor with the kiosk and having it evaluated by professional border guards. The intelligent agent used the neutral demeanor for this study, but projecting power and dominance during the entire interaction may not be the best strategy. The border guard participants admitted feeling nervous during their interaction with the intelligent agent in the male neutral state. This increased arousal across the whole interaction likely contributed to elevated mean pitch across all participants, leaving little room for variation between conditions. The variance of the pitch reflects both stress and uncertainty. Similar to when a question is posed, inclinations of pitch toward the end of a message connote uncertainty.

Intelligent agents used to conduct interviews included embodiments to change human perceptions of the system by manipulating genders and demeanors of intelligent agents. In other embodiments, other and/or additional aspects of intelligent agents can be changed. For example, some of these aspects can include intelligent agent ethnicity, apparent age of the intelligent agent (young, middle-aged, elderly, in his/her 20s, in his/her 30s, etc.), costuming (uniformed versus casual), vocal volume, size, clothing, hair. Many other aspects of intelligent agent s can be changed as well.

While performing an analysis of the embodied states, an evaluation was made how the various question blocks (shown in Table 8) also affected perceptions. The content of the questions was investigated as to how content may have affected the perceptions of the users independent of the embodied gender and demeanor. As it relates to power, there was a significant effect on perception from the question block (F(1,80)=4.5756, p<0.05), where the first block of questions was perceived as the most powerful. Similarly, the third block of questions had an effect on perceived trustworthiness (F(1,80)=5.61, p<0.05), perceived expertise (F(1, 80)=9.3877, p<0.01), and likability (F(1,80)=9.0127,p<0.01).

### Fraudulent Document Experiment Utilizing Multiple Sensors

Thirty-seven border guards from 19 EU nations and two United States border guards participated in a document-based experiment of SPECIES agents utilizing multiple sensors. Each participant was provided with a visa document containing personal data: given name, surname, date of birth, place of birth, and nationality. The visa document contained a machine readable portion encoding a country name, the participant's given name and surname, a document number, the participant's date of birth, and the participant's gender. For the sake of the experiment, all documents were assumed to be genuine (not counterfeited/falsified).

Four of the thirty-nine participants (two men and two women) acted as “imposters”—each imposter was provided with a fraudulent visa document with an incorrect date of birth. All participants were asked to pass through a border checkpoint. At the checkpoint, an automated system used an embodied conversational agent, such as intelligent agent 310, to interview each participant.

During the experiment, intelligent agent 310 was in the neutral male agent state and used an avatar similar to avatar 530 shown in FIG. 5. Each participant was asked the same questions, in the same order and the same way each time. In addition, the automated system was configured to enable intelligent agent 310 to speak five languages (English, Polish, Spanish, French, and German) while conducting participant interviews.

Three sensors were used to detect deception in participants: a microphone for gathering vocalic and other data, an eye tracker for detecting ocular behavior, and an electronic passport reader. The microphone and eye tracker are discussed above in more detail in the “Detecting Deception and Related Sensors” sections above, and the electronic passport reader is discussed above in more detail in the context of FIG. 1 above.

At the onset of the experiment, each participant was given a visa document, as discussed above. The four imposters were also given basic instructions on the checkpoint scenario and their role in the experiment; as imposters, they each had acquired genuine documents of a person who looked like the imposter and whose name was identical to the imposter. The imposter's goal was to pass through the checkpoint undetected, meet with accomplices, and place a bomb at a reception. The imposters were instructed the day before the experiment to check his or her visa document and note that the date and location of their birth was false.

The imposters were asked to lie and answer affirmatively when intelligent agent 310 asked him or her whether the document belonged to them and if the data were correct. In order to reinforce the imposters in their role, on the day before the experiment, they were invited to meet in secret in the reception room and discuss how they would set up a bomb scare. The other participants were simply told to behave normally. All other participants and experimental staff were blind to the identity of the imposters.

Upon arrival at the checkpoint, the participants first scanned their documents using the electronic passport reader and selected a language (English, Polish, Spanish, French, or German) for an interview. Intelligent agent 310 then asked the following questions:

1. What is your full name?

2. Where were you born?

3. Do have anything to declare?

4. What is the purpose of your visit?

5. Please carefully examine the following document.
a. Scanned document shown (15 seconds)

6. Are the data on this document correct?
a. Scanned document shown (15 seconds)

7. Is this your document?

During each response, the sensors monitored the vocal and ocular behavior of the participants. Vocal and ocular behavior were then assessed.

To assess the relationship between the voice and the participant's interview responses a multilevel model was specified with vocal quality as the response variable (N=189) regressed on condition (Guilty/Innocent) and question number (time). To reflect the repeated measure experimental design of multiple questions, both time and the intercept of vocal quality were modeled to vary within Subject (N=38) as random effects. To calibrate each speaker each measurement of voice quality was subtracted by a starting value to reflect the deviance from a neutral starting point (Question One).

Table 19 below lists the fixed effects from this analysis. The imposters had a significantly larger drop in voice quality during the interview than innocent participants, b=−2.18, p<0.01. Innocent participants and imposters both dropped their voice quality over time, likely because of the stress of the interview in contrast to the benign starting question.

TABLE 19
Vocal Behavior Fixed Effects (N = 189, 38 subjects)

| Fixed Effects | β |
|---|---|
| Intercept | −0.136 |
| Imposter | −2.180, p < .01 |
| Time (Question) | −0.134, p < .05 |

The imposters spoke with much lower vocal quality when answering questions related to their identity (questions 5, 6, and 7 above). Specifically, the vocal quality of imposters changed by about −2.5 dB in contrast to a −0.5 dB change in vocal quality for other participants.

However, eye contact with intelligent agent 310 was not predictive of deception. A Between Subjects ANOVA revealed that when participants were asked to examine the image of their visa, imposters spent much more time fixating on the incorrect date of birth information, F(1,36)=5.18, p=0.028, η²=0.14. Imposters spent 2.12 times more time fixating on the incorrect date of birth fields on their visa—imposters spent a mean amount of 29.73 seconds (SD=35.63) fixating on the birth fields, while other participants spent a mean amount of 13.99 seconds (SD=8.45) fixating on the birth fields.

To summarize the predictive potential of each of the collected vocal and eye gaze behavior measurements, each were submitted to Between Subjects ANOVA. Table 20 below details the results for each measurement as a predictor of an imposter when answering question six (“Are the data on this document correct?”).

TABLE 20
Vocal and Eye Gaze Behavior ANOVA Summary

| Predictor | df | F | p |
|---|---|---|---|
| Vocal Pitch Mean | 36 | 0.05 | .83 |
| Vocal Pitch SD | 36 | 0.30 | .58 |
| Vocal Quality Mean | 36 | 8.78 | <.01 |
| Vocal Quality SD | 36 | 0.29 | .59 |
| Vocal Intensity Mean | 36 | 1.65 | .21 |
| Vocal Intensity SD | 36 | 0.82 | .37 |
| Birth Data Eye Fixation | 36 | 5.18 | .03 |
| Pupil Dilation | 36 | 0.04 | .83 |

Table 20 indicates that the Vocal Quality Mean predictor has a p value of less than 0.01 and the Birth Date Eye Fixation predictor has a p value of 0.03. Both are less than a p=0.05 value so the null hypotheses that all data are sampled from populations with the same mean value for the Vocal Quality Mean predictor or the Birth Date Eye Fixation predictor can be rejected.

Vocal quality and data of birth fixation were then submitted to a recursive partitioning classification algorithm leading to the following decision rules:
1. IF a change in the Vocal Quality Mean value for a subject is greater than or equal in absolute value to −2.54 dB, THEN the subject is guilty;
2. ELSE IF Birth Data Eye Fixation time is greater than a predetermined value, THEN the subject is guilty; ELSE
3. ELSE the subject is innocent.

The final model using the decision rules above had an accuracy of 94.47% and correctly identified all imposers while misclassifying two other participants of being imposters. Use of the Birth Data Eye Fixation data reduced the number of false positives from a model using only Vocal Quality Mean data alone.

This classification model illustrated the importance of additional sensors for improving overall accuracy of prediction, not just focusing entirely on true positives, or identifying imposters. Falsely accusing too many people would make the system infeasible in a high throughput, operational scenario. The diverse nature of the participants suggests that gender, language, and potential cultural differences did not affect the results.

### Example Computing Environment

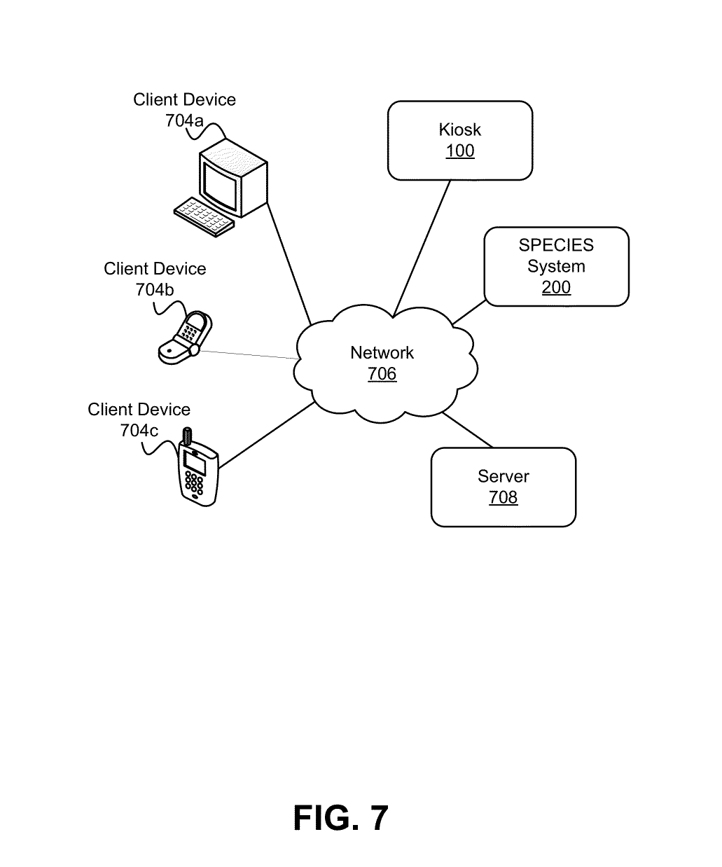

FIG. 7 is a block diagram of an example computing network. Some or all of the above-mentioned techniques disclosed herein, such as but not limited to techniques disclosed as part of and/or being performed by a kiosk, agent, SPECIES agent, SPECIES system, and/or intelligent agent, can be part of and/or performed by a computing device. For example, FIG. 7 shows kiosk 100 and/or SPECIES system 200 each configured to communicate, via network 706, with client devices 704a, 704b, and 704c.

Network 706 may correspond to a LAN, a wide area network (WAN), a corporate intranet, the public Internet, or any other type of network configured to provide a communications path between networked computing devices. Network 706 may also correspond to a combination of one or more LANs, WANs, corporate intranets, and/or the public Internet.

Although FIG. 7 only shows three client devices 704a, 704b, 704c, distributed application architectures may serve tens, hundreds, or thousands of client devices. Moreover, client devices 704a, 704b, 704c (or any additional client devices) may be any sort of computing device, such as an ordinary laptop computer, desktop computer, network terminal, wireless communication device (e.g., a cell phone or smart phone), and so on. In some embodiments, client devices 704a, 704b, 704c can be dedicated to interacting with kiosk 100 and/or SPECIES system 200. In other embodiments, client devices 704a, 704b, 704c can be used as general purpose computers that are configured to perform a number of tasks and need not be dedicated to problem solving. In still other embodiments, part or all of the functionality of kiosk 100 and/or SPECIES system 200 can be incorporated in a client device, such as client device 704a, 704b, and/or 704c.

### Computing Device Architecture

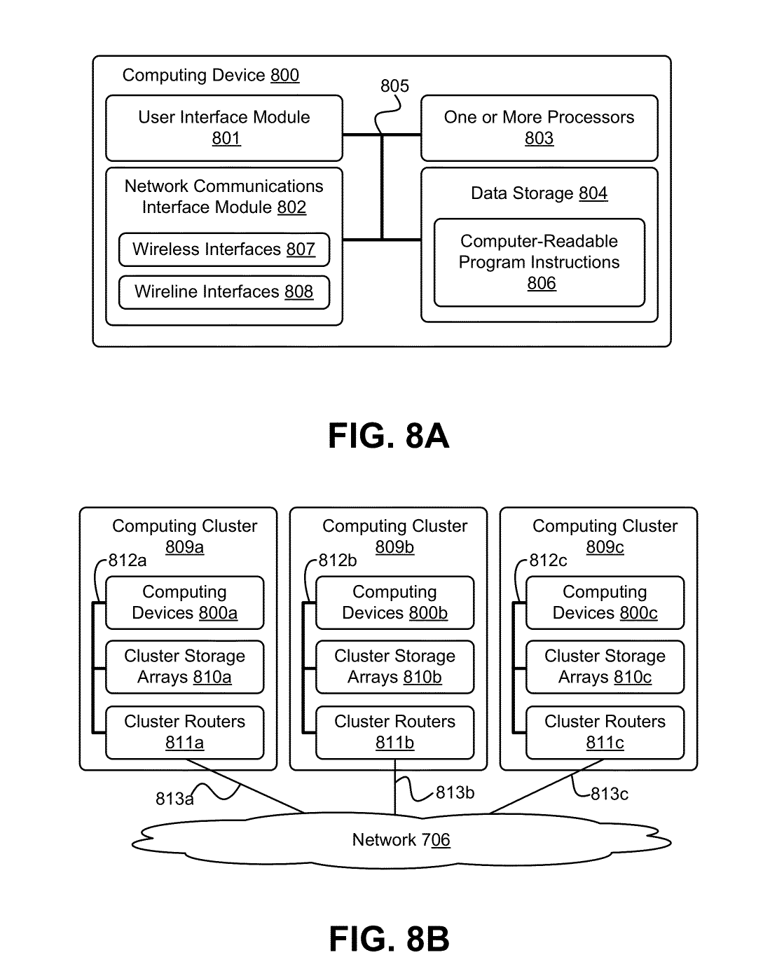

FIG. 8A is a block diagram of an example computing device (e.g., system). In particular, computing device 800 shown in FIG. 8A can be configured to: (i) include components of and/or perform one or more functions or operations of kiosk 100, SPECIES system 200, a SPECIES agent, intelligent agent 310, client device 704a, 704b, 704c, network 706, and/or (iii) carry out part or all of any herein-described methods, such as but not limited to method 900. Computing device 800 may include a user interface module 801, a network-communication interface module 802, one or more processors 803, and data storage 804, all of which may be linked together via a system bus, network, or other connection mechanism 805.

User interface module 801 can be operable to send data to and/or receive data from external user input/output devices. For example, user interface module 801 can be configured to send and/or receive data to and/or from user input devices such as a keyboard, a keypad, a touch screen, a computer mouse, a track ball, a joystick, a camera, a voice recognition module, and/or other similar devices. User interface module 801 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, either now known or later developed. User interface module 801 can also be configured to generate audible output(s), such as a speaker, speaker jack, audio output port, audio output device, earphones, and/or other similar devices.

Network-communications interface module 802 can include one or more wireless interfaces 807 and/or one or more wireline interfaces 808 that are configurable to communicate via a network, such as network 706 shown in FIG. 7. Wireless interfaces 807 can include one or more wireless transmitters, receivers, and/or transceivers, such as a Bluetooth transceiver, a Zigbee transceiver, a Wi-Fi transceiver, a WiMAX transceiver, and/or other similar type of wireless transceiver configurable to communicate via a wireless network. Wireline interfaces 808 can include one or more wireline transmitters, receivers, and/or transceivers, such as an Ethernet transceiver, a Universal Serial Bus (USB) transceiver, or similar transceiver configurable to communicate via a twisted pair, one or more wires, a coaxial cable, a fiber-optic link, or a similar physical connection to a wireline network.

In some embodiments, network communications interface module 802 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

Processors 803 can include one or more general purpose processors and/or one or more special purpose processors (e.g., digital signal processors, application specific integrated circuits, etc.). Processors 803 can be configured to execute computer-readable program instructions 806 contained in data storage 804 and/or other instructions as described herein. Data storage 804 can include one or more computer-readable storage media that can be read and/or accessed by at least one of processors 803. The one or more computer-readable storage media can include volatile and/or non-volatile storage components, such as optical, magnetic, organic or other memory or disc storage, which can be integrated in whole or in part with at least one of processors 803. In some embodiments, data storage 804 can be implemented using a single physical device (e.g., one optical, magnetic, organic or other memory or disc storage unit), while in other embodiments, data storage 804 can be implemented using two or more physical devices.

Data storage 804 can include computer-readable program instructions 806 and perhaps additional data. For example, in some embodiments, data storage 804 can store part or all of data utilized by a SPECIES system; e.g., kiosk 100 and/or SPECIES system 200. In some embodiments, data storage 804 can additionally include storage required to perform at least part of the herein-described methods and techniques and/or at least part of the functionality of the herein-described devices and networks.

FIG. 8B depicts a network 706 of computing clusters 809a, 809b, 809c arranged as a cloud-based server system in accordance with an example embodiment. Data and/or software for kiosk 100 and/or SPECIES system 200 can be stored on one or more cloud-based devices that store program logic and/or data of cloud-based applications and/or services. In some embodiments, kiosk 100 and/or SPECIES system 200 can be a single computing device residing in a single computing center. In other embodiments, kiosk 100 and/or SPECIES system 200 can include multiple computing devices in a single computing center, or even multiple computing devices located in multiple computing centers located in diverse geographic locations.

In some embodiments, data and/or software for kiosk 100 and/or SPECIES system 200 can be encoded as computer readable information stored in tangible computer readable media (or computer readable storage media) and accessible by client devices 704a, 704b, and 704c, and/or other computing devices. In some embodiments, data and/or software for kiosk 100 and/or SPECIES system 200 can be stored on a single disk drive or other tangible storage media, or can be implemented on multiple disk drives or other tangible storage media located at one or more diverse geographic locations.

FIG. 8B depicts a cloud-based server system in accordance with an example embodiment. In FIG. 8B, the operations of kiosk 100 and/or SPECIES system 200 can be distributed among three computing clusters 809a, 809b, and 808c. Computing cluster 809a can include one or more computing devices 800a, cluster storage arrays 810a, and cluster routers 811a connected by a local cluster network 812a. Similarly, computing cluster 809b can include one or more computing devices 800b, cluster storage arrays 810b, and cluster routers 811b connected by a local cluster network 812b. Likewise, computing cluster 809c can include one or more computing devices 800c, cluster storage arrays 810c, and cluster routers 811c connected by a local cluster network 812c.

In some embodiments, each of the computing clusters 809a, 809b, and 809c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 809a, for example, computing devices 800a can be configured to perform various computing tasks of kiosk 100 and/or SPECIES system 200. In one embodiment, the various functionalities of kiosk 100 and/or SPECIES system 200 can be distributed among one or more of computing devices 800a, 800b, and 800c. Computing devices 800b and 800c in computing clusters 809b and 809c can be configured similarly to computing devices 800a in computing cluster 809a. On the other hand, in some embodiments, computing devices 800a, 800b, and 800c can be configured to perform different operations.

In some embodiments, computing tasks and stored data associated with kiosk 100 and/or SPECIES system 200 can be distributed across computing devices 800a, 800b, and 800c based at least in part on the processing requirements of kiosk 100 and/or SPECIES system 200, the processing capabilities of computing devices 800a, 800b, and 800c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 810a, 810b, and 810c of the computing clusters 809a, 809b, and 809c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the operations of kiosk 100 and/or SPECIES system 200 can be distributed across computing devices 800a, 800b, and 800c of computing clusters 809a, 809b, and 809c, various active portions and/or backup portions of these components can be distributed across cluster storage arrays 810a, 810b, and 810c. For example, some cluster storage arrays can be configured to store one portion of the data and/or software of kiosk 100 and/or SPECIES system 200, while other cluster storage arrays can store a separate portion of the data and/or software of kiosk 100 and/or SPECIES system 200. Additionally, some cluster storage arrays can be configured to store backup versions of data stored in other cluster storage arrays.

The cluster routers 811a, 811b, and 811c in computing clusters 809a, 809b, and 809c can include networking equipment configured to provide internal and external communications for the computing clusters. For example, the cluster routers 811a in computing cluster 809a can include one or more internet switching and routing devices configured to provide (i) local area network communications between the computing devices 800a and the cluster storage arrays 801a via the local cluster network 812a, and (ii) wide area network communications between the computing cluster 809a and the computing clusters 809b and 809c via the wide area network connection 813a to network 706. Cluster routers 811b and 811c can include network equipment similar to the cluster routers 811a, and cluster routers 811b and 811c can perform similar networking operations for computing clusters 809b and 809b that cluster routers 811a perform for computing cluster 809a.

In some embodiments, the configuration of the cluster routers 811a, 811b, and 811c can be based at least in part on the data communication requirements of the computing devices and cluster storage arrays, the data communications capabilities of the network equipment in the cluster routers 811a, 811b, and 811c, the latency and throughput of local networks 812a, 812b, 812c, the latency, throughput, and cost of wide area network links 813a, 813b, and 813c, and/or other factors that can contribute to the cost, speed, fault-tolerance, resiliency, efficiency and/or other design goals of the moderation system architecture.

### Example Methods of Operation

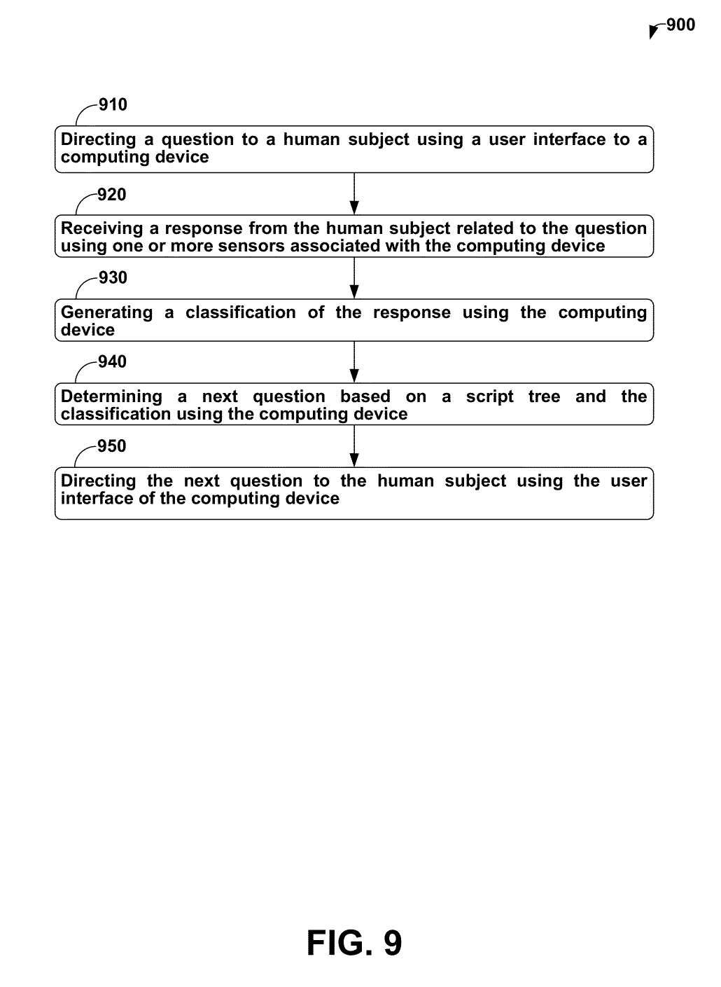

FIG. 9 is a flow chart of an example method 900. Method 900 can begin at block 910, where a user interface to a computing device can direct a question to a human subject. In some embodiments, directing the question to the human subject can include communicating the question to the human subject using an intelligent agent of the computing device, where the intelligent agent can include an animation of a human face. In particular embodiments, the intelligent agent can be configured to communicate with the human subject using generated speech based upon one or more voice parameters. In some particular embodiments, the one or more voice parameters can include at least one voice parameter selected from the group consisting of a gender voice parameter, a pitch voice parameter, a tempo voice parameter, a volume voice parameter, and an accent voice parameter.

In other embodiments, the human face can be selected to be either a human face representing a male agent or a human face representing a female agent. In still other embodiments, the human face can be selected to be either a human face representing a neutral agent or a human face representing a smiling agent.

At block 920, one or more sensors associated with the computing device can receive a response from the human subject related to the question. In some embodiments, receiving the response related to the question can include displaying a gesture using the intelligent agent, where the gesture is based on the question. In particular embodiments, the gesture is at least one gesture selected from the group consisting of a head nod gesture, a head shake gesture, and a smile gesture. In other embodiments, the sensor is configured to be controlled by the intelligent agent.

At block 930, the computing device can generate a classification of the response. In some embodiments, the response can include speech from the human subject and generating the classification of the response can include analyzing the speech from the human subject. In particular embodiments, analyzing the speech from the human subject can include: determining an average pitch of the speech from the human subject; determining a pitch and a harmonics-to-noise ratio (HNR) of a portion of the speech from the human subject, wherein the HNR determines a voice quality; determining whether the pitch is above the average pitch and determining whether the HNR increases in the speech from the human subject; in response to determining that the pitch is below the average pitch and that the HNR increases, classifying the response as a response to a stressful question; and in response to determining that the pitch is above the average pitch and that the HNR increases, classifying the response as a potentially untruthful response.

In other embodiments, analyzing the speech from the human subject can include: determining a value based on the pitch of the speech from the human subject; determining whether the value based on the pitch is above a threshold value; and in response to determining that the value based on the pitch is above the threshold value, classifying the response as a response to a stressful question.

At block 940, the computing device can determine a next question based on the script tree and the classification.

At block 950, the user interface of the computing device can direct the next question to the human subject.

### CONCLUSION

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The above description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

Numerous modifications and variations of the present disclosure are possible in light of the above teachings.

1. A system, comprising:
a processor;
a user interface;
one or more sensors;
a non-transitory computer readable medium configured to store at least a script tree and program instructions that, upon execution by the processor, cause the system to perform operations comprising:
directing a question to a human subject using the user interface;
receiving a response from the human subject related to the question using the one or more sensors;
generating a classification of the response;
determining a next question based on the script tree and the classification; and
directing the next question to the human subject using the user interface.

2. The system of claim 1, wherein the operation of directing the question to the human subject comprises communicating the question to the human subject using an intelligent agent and the user interface, wherein the intelligent agent comprises an animation of a human face.

3. The system of claim 2, wherein the operation of receiving the response related to the question comprises displaying a gesture using the intelligent agent, wherein the gesture is based on the question.

4. The system of claim 3, wherein the gesture is at least one gesture selected from the group consisting of a head nod gesture, a head shake gesture, and a smile gesture.

5. The system of claim 2, wherein the intelligent agent is configured to communicate with the human subject using generated speech based upon one or more voice parameters.

6. The system of claim 5, wherein the one or more voice parameters comprise at least one voice parameter selected from the group consisting of a gender voice parameter, a pitch voice parameter, a tempo voice parameter, a volume voice parameter, and an accent voice parameter.

7. The system of claim 2, wherein the one or more sensors are configured to be controlled by the intelligent agent.

8. The system of claim 2, wherein the human face is selected to be either a human face representing a male agent or a human face representing a female agent.

9. The system of claim 2, wherein the human face is selected to be either a human face representing a neutral agent or a human face representing a smiling agent.

10. The system of claim 1, wherein the response comprises speech from the human agent, and wherein the operation of generating the classification of the response comprises analyzing the speech from the human subject.

11. The system of claim 10, wherein analyzing the speech from the human subject comprises:
determining an average pitch of the speech from the human subject;
determining a pitch and a harmonics-to-noise ratio (HNR) of a portion of the speech from the human subject, wherein the HNR determines a voice quality;
determining whether the pitch is above the average pitch and determining whether the HNR increases in the portion of the speech from the human subject;
in response to determining that the pitch is below the average pitch and that the HNR increases, classifying the response as a response to a stressful question; and
in response to determining that the pitch is above the average pitch and that the HNR increases, classifying the response as a potentially untruthful response.

12. The system of claim 10, wherein analyzing the speech from the human subject comprises:
determining a value based on the pitch of the speech from the human subject;
determining whether the value based on the pitch is above a threshold value; and
in response to determining that the value based on the pitch is above the threshold value, classifying the response as a response to a stressful question.

13. The system of claim 1, further comprising an operator interface to the user interface, wherein the operator interface is configured to provide information about the question, the response, and the classification.

14. A method, comprising:
directing a question to a human subject using a user interface to a computing device;
receiving a response from the human subject related to the question using one or more sensors associated with the computing device;
generating a classification of the response using the computing device;
determining a next question based on a script tree and the classification using the computing device; and
directing the next question to the human subject using the user interface of the computing device.

15. The method of claim 14, wherein directing the question to the human subject comprises communicating the question to the human subject using an intelligent agent of the computing device, wherein the intelligent agent comprises an animation of a human face.

16. The method of claim 15, wherein receiving the response related to the question comprises displaying a gesture using the intelligent agent, wherein the gesture is based on the question.

17. The method of claim 16, wherein the gesture is at least one gesture selected from the group consisting of a head nod gesture, a head shake gesture, and a smile gesture.

18. The method of claim 15, wherein the intelligent agent is configured to communicate with the human subject using generated speech based upon one or more voice parameters.

19. The method of claim 18, wherein the one or more voice parameters comprise at least one voice parameter selected from the group consisting of a gender voice parameter, a pitch voice parameter, a tempo voice parameter, a volume voice parameter, and an accent voice parameter.

20. The method of claim 15, wherein the one or more sensors are configured to be controlled by the intelligent agent.

21. The method of claim 15, wherein the human face is selected to be either a human face representing a male agent or a human face representing a female agent.

22. The method of claim 15, wherein the human face is selected to be either a human face representing a neutral agent or a human face representing a smiling agent.

23. The method of claim 14, wherein the response comprises speech from the human subject, and wherein generating the classification of the response comprises analyzing the speech from the human subject.

24. The method of claim 23, wherein analyzing the speech from the human subject comprises:
determining an average pitch of the speech from the human subject;
determining a pitch and a harmonics-to-noise ratio (HNR) of a portion of the speech from the human subject, wherein the HNR determines a voice quality;
determining whether the pitch is above the average pitch and determining whether the HNR increases in the portion of the speech from the human subject;
in response to determining that the pitch is below the average pitch and that the HNR increases, classifying the response as a response to a stressful question; and
in response to determining that the pitch is above the average pitch and that the HNR increases, classifying the response as a potentially untruthful response.

25. The method of claim 23, wherein analyzing the speech from the human subject comprises:
determining a value based on a pitch of the speech from the human subject;
determining whether the value based on the pitch is above a threshold value; and
in response to determining that the value based on the pitch is above the threshold value, classifying the response as a response to a stressful question.

26. The method of claim 14, further comprising:
providing information about the question, the response, and the classification via an operator interface to the user interface.

27. A non-transitory computer-readable storage medium having stored thereon program instructions that, upon execution by a computing device, cause the computing device to perform operations comprising:
directing a question to a human subject using a user interface to a computing device;
receiving a response from the human subject related to the question using one or more sensors associated with the computing device;
generating a classification of the response using the computing device;
determining a next question based on a script tree and the classification using the computing device; and
directing the next question to the human subject using the user interface of the computing device.

28. The non-transitory computer-readable storage medium of claim 27, wherein the operation of directing the question to the human subject comprises communicating the question to the human subject using an intelligent agent of the computing device, wherein the intelligent agent comprises an animation of a human face.

29. The non-transitory computer-readable storage medium of claim 28, wherein the operation of receiving the response related to the question comprises displaying a gesture using the intelligent agent, wherein the gesture is based on the question.

30. The non-transitory computer-readable storage medium of claim 29, wherein the gesture is at least one gesture selected from the group consisting of a head nod gesture, a head shake gesture, and a smile gesture.

31. The non-transitory computer-readable storage medium of claim 28, wherein the intelligent agent is configured to communicate with the human subject using generated speech based upon one or more voice parameters.

32. The non-transitory computer-readable storage medium of claim 31, wherein the one or more voice parameters comprise at least one voice parameter selected from the group consisting of a gender voice parameter, a pitch voice parameter, a tempo voice parameter, a volume voice parameter, and an accent voice parameter.

33. The non-transitory computer-readable storage medium of claim 28, wherein the one or more sensors are configured to be controlled by the intelligent agent.

34. The non-transitory computer-readable storage medium of claim 28 wherein the human face is selected to be either a human face representing a male agent or a human face representing a female agent.

35. The non-transitory computer-readable storage medium of claim 28, wherein the human face is selected to be either a human face representing a neutral agent or a human face representing a smiling agent.

36. The non-transitory computer-readable storage medium of claim 27, wherein the response comprises speech from the human agent, and wherein the operation of generating the classification of the response comprises analyzing the speech from the human subject.

37. The non-transitory computer-readable storage medium of claim 36, wherein analyzing the speech from the human subject comprises:
determining an average pitch of the speech from the human subject;
determining a pitch and a harmonics-to-noise ratio (HNR) of a portion of the speech from the human subject, wherein the HNR determines a voice quality;
determining whether the pitch is above the average pitch and determining whether the HNR increases in the portion of the speech from the human subject;
in response to determining that the pitch is below the average pitch and that the HNR increases, classifying the response as a response to a stressful question; and
in response to determining that the pitch is above the average pitch and that the HNR increases, classifying the response as a potentially untruthful response.

38. The non-transitory computer-readable storage medium of claim 36, wherein analyzing the speech from the human subject comprises:
determining a value based on the pitch of the speech from the human subject;
determining whether the value based on the pitch is above a threshold value; and
in response to determining that the value based on the pitch is above the threshold value, classifying the response as a response to a stressful question.

39. The non-transitory computer-readable storage medium of claim 27, wherein the functions further comprise:
providing information about the question, the response, and the classification via an operator interface to the user interface.
